(19) United States
(12) Patent Application Publication
(10) Pub. No.: US 2025/0105962 A1
(43) Pub. Date: Mar. 27, 2025

(54) METHODS AND DEVICES TO PERFORM RADIO COMMUNICATION USING CHANNEL ESTIMATES

(71) Applicant: Intel Corporation, Santa Clara, CA (US)

(72) Inventors: Sagar DHAKAL, Los Altos, CA (US); Yang-Seok CHOI, Portland, OR (US); Jan SCHRECK, Scotts Valley, CA (US); Thushara HEWAVITHANA, Tempe, AZ (US); Nicholas WHINNETT, Bath (GB)

(21) Appl. No.: 18/471,334

(22) Filed: Sep. 21, 2023

(51) Int. Cl. H04L 5/00; H04L 25/02

(52) U.S. Cl. CPC H04L 5/0048; H04L 25/0224

(57) ABSTRACT

A radio communication device may include a memory; and a processor configured to: perform a plurality of channel estimations based on a received radio signal comprising a plurality of reference signals of a plurality of mobile radio communication devices, wherein each channel estimation of the plurality of channel estimations is for a respective mobile radio communication device of the plurality of communication devices; determine a residual signal for the plurality of mobile radio communication devices based on the plurality of channel estimations; and estimate channel information for at least one mobile radio communication device from the plurality of radio communication device based on the residual signal and an estimated power delay profile.

### TECHNICAL FIELD

This disclosure generally relates to methods and devices to perform radio communication using estimated channel information.

### BACKGROUND

In radio communication networks in accordance with many radio communication technologies, such as Fourth Generation (LTE) and Fifth Generation (5G) New Radio (NR), various methods are employed to provide wireless data transfer with desired efficiency, speed, and reliability. One of these methods involves employing reference signals allowing the receiver of the reference signals to obtain information about the communication channel, which may be subject to various effects such as fading, multipath propagation, propagation loss, interference.

Within the landscape of radio communication technologies like Fourth Generation (LTE) and Fifth Generation (5G) New Radio (NR), orthogonal reference signals may be used to obtain information about channel conditions, which may allow the receiver to estimate channels accurately, in particular given the presence of beamforming and/or spatial multiplexing within the context of multiple input multiple output (MIMO) communication. For example, sounding reference signals (SRS) may be configured as reference signals, based on which a base station (BS) may estimate channel quality and characteristics to optimize transmission parameters and resource allocation for uplink data. Another example may include demodulation reference signals (DM-RS), based on which a user equipment (UE) may estimate channel quality and characteristics to adapt its reception strategies and enhance data decoding.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosure. In the following description, various aspects of the disclosure are described with reference to the following drawings, in which:

FIG. 1 shows an exemplary radio communication network;

FIG. 2 shows an exemplary internal configuration of a communication device;

FIG. 3 shows an exemplary illustration of a channel estimation procedure for multiple mobile radio communication devices within a radio access network;

FIG. 4 shows an exemplary illustration of a resource grid for radio communication, complimenting the resource grid of LTE/5G;

FIG. 5 shows an example of an apparatus of a radio communication device according to various examples in this disclosure;

FIG. 6 shows an exemplary illustration of a block diagram to describe various aspects of the channel estimation in separate units;

FIG. 7 shows an example of a neural network in accordance with various aspects provided herein;

FIG. 8 shows an exemplary block diagram of a channel estimation in accordance with various aspects provided herein;

FIG. 9 shows an exemplary block diagram of a channel estimation in accordance with various aspects provided herein;

FIG. 10 shows an exemplary block diagram of a channel estimation in accordance with various aspects;

FIG. 11 shows an exemplary block diagram of a channel estimation in accordance with various aspects;

FIG. 12 illustrates an exemplary graph illustrating the mean squared error performances of channel estimations;

FIG. 13 illustrates an exemplary graph illustrating the mean squared error performances of channel estimations;

FIG. 14 shows an example of a method;

FIG. 15 shows an example of a method.

### DESCRIPTION

The following detailed description refers to the accompanying drawings that show, by way of illustration, exemplary details and aspects in which aspects of the present disclosure may be practiced.

Channel estimation through reference signals is crucial for both radio communication devices, access nodes such as base stations (BS), and mobile radio communication devices (e.g. terminal devices, such as UEs). For access nodes, accurate channel estimation is essential for optimizing resource allocation, transmission parameters, and beamforming strategies. Through this optimization, efficient use of the wireless channel, minimized interference, and network performance improvements may be enabled. Similarly, terminal devices may rely on precise channel estimation to enhance signal reception, adapt modulation schemes, and ensure smooth handovers between cells. Channel information may help terminal devices decode signals effectively, allocate power efficiently, and utilize advanced techniques like spatial multiplexing. Accordingly, an accurate channel estimation may benefit both access nodes and terminal devices within a radio access network, facilitating reliable and efficient communication across the wireless network.

For example, in the cellular communication context, Sounding Reference Signals (SRS) may be considered to have a vital role in accurate channel estimation for both BSs and mobile radio communication devices (UEs). By transmitting predefined signals with known attributes (i.e. reference signals or pilot signals), UEs may provide BSs with insights into the wireless channel's behavior. Accordingly, BSs can adjust transmission parameters, allocate resources, and adjust beamforming strategies for optimization. UEs may correspondingly benefit from improved signal reception, adaptive modulation, and reliable handovers, leading to enhanced overall communication quality. SRS-based channel estimation may result in efficient communication by enabling both BSs and UEs to make informed decisions and adapt to changing network conditions.

Similarly, Demodulation Reference Signals (DMRS) may be considered to have a critical role in achieving precise channel estimation for both BSs and UEs. Through the transmission of predefined signals possessing known characteristics (such as reference signals or pilot signals), UEs may furnish BSs with valuable insights into the dynamics of the wireless channel. Accordingly, BSs may fine-tune transmission parameters, judiciously allocate resources, and optimize beamforming strategies. Correspondingly, UEs may experience enhanced signal reception, adaptive modulation capabilities, and dependable handover mechanisms, collectively elevating the overall quality of communication. The utilization of DMRS-based channel estimation fosters an environment of efficient communication, where BSs and UEs alike are configured to make informed decisions and adapt efficiently to changing network landscape.

However, there are various challenges associated with performing an accurate channel estimation via employment of reference signals. One of these challenges may include the contamination of reference signals, which may refer to the challenge of estimating the wireless channel of a UE from the reference signal received from that UE, while contending with interference arising from reference signals transmitted by other UEs. This phenomenon may be referred to as “pilot contamination” or “reference signal contamination”, which may be considered as prevalent in uplink cellular communication systems such as 4G, 5G, and beyond. This issue may arise in various contexts, including sounding reference symbols (SRS) or demodulation reference symbols (DMRS). In such scenarios, the presence of interfering reference signals from other UEs (e.g. neighboring UEs) can impair accurate channel estimation, impacting the reliability of communication and forcing to apply sophisticated interference mitigation techniques to achieve optimal performance.

Various aspects provided in this disclosure, which may improve accuracy and efficiency of channel estimation based on received reference signals, in particular within deployment and allocation scenarios that are subject to considerable interference between reference signals which may result in contamination of the reference signals. Accordingly, in view of the conventional methods employing solely the orthogonality of reference signals or user specific time shifts and windowing, the aspects described herein may allow to load more UEs per sounding channel resource (i.e. accommodate a higher number of UEs using a single set of radio communication resources (e.g. time and frequency resources)). Illustratively, the BS may configure an increased number of UEs per an SRS resource, which the BS may convey using layer-2 information.

In other words, as the number of UEs scheduled to use the same radio communication resources increases, with the employment of various aspects provided in this disclosure, the cross-interference of reference signals may not result in degradation of channel estimate accuracy as the degradation when conventional methods are used. Illustratively, considering that channel quality indicators (CQIs) may be obtained based on these reference signals, CQIs obtained using various aspects provided herein may not degrade as much as CQIs obtained using conventional channel estimation methods.

Various aspects described herein may include performing at least one power-delay profile (PDP) estimate. A power delay profile may provide an indication of the signal power received on each multipath as a function of the propagation delays of the respective multipaths. Illustratively, when the PDP is denoted as an intensity function, the PDP may be formulated as, S(τ) being the intensity function of delay, and E[|h(t,τ)|²] being the spatial average of the complex channel impulse response:

$$S ( τ ) = E [ {\vert h ( t , τ ) \vert}^{2} ]$$

Various aspects provided herein include a processor configured to estimate a PDP of a channel estimate. In some examples, the channel estimate may be based on a channel estimation according to a predetermined or predefined channel estimation method. However, instead of using that particular channel estimation to configure radio communication operations, the processor may perform a further channel estimation based on the estimated PDP. In some aspects, the initial channel estimation used to provide input to the PDP estimation methods may be referred to as a coarse channel estimation. The term “coarse” principally intends to refer to the aspect that this initial channel estimation is subject to an optimization or improvement through obtaining a further channel estimate (e.g. channel information (e.g. CQI) for a UE). In some aspects, the initial channel estimation, based on which the PDP estimation is performed, may be referred to as a first channel estimation, and the further channel estimation that is based on the output of the PDP estimation may be referred to as a second channel estimation within this disclosure. Illustratively, the first channel estimation may be performed using a matched filter or applying a zero forcing (ZF).

In some aspects, a processor may include a PDP estimator. The PDP estimator may be configured to perform a PDP estimation. The PDP estimation may be a PDP estimation of an estimated channel. Accordingly, the PDP estimator may receive an input of channel information representative of a channel estimate. Correspondingly, the PDP estimator may provide an output including estimated PDP values. In some examples, the estimated channel may be a communication channel of a mobile radio communication device (e.g. communication channel between the mobile radio communication device and an access node). Accordingly, the estimated PDP values may be for the mobile radio communication device.

In some aspects, the PDP estimator may include an artificial neural network trained in manner that a received channel estimate is mapped to PDP values. The training of the artificial neural network may be perform according to a supervised training method, by mapping training input data including predetermined channel estimates to corresponding training output data including predetermined PDP values corresponding to predetermined channel estimates.

In accordance with various aspects provided herein, a processor may perform interference cancellation techniques to perform the second channel estimation to cancel out cross interference within received reference signals. Performed techniques may include time domain interference cancellation techniques and/or frequency domain interference cancellation techniques. In some examples, performed interference cancellation techniques are based on the PDP estimation.

Various aspects provided herein may include a processor configured to obtain a residual signal for each mobile radio communication device of a plurality of mobile radio communication devices based on a reference signal associated with (e.g. used by, assigned to) the respective mobile radio communication device and a received radio signal including transmit signals of the plurality of mobile radio communication devices. The transmit signals may include a corresponding reference signal transmitted by each mobile radio communication device.

The apparatuses and methods of this disclosure (i.e. radio communication devices and mobile radio communication devices, together with methods described herein) may utilize or be related to radio communication technologies. While some examples may refer to specific radio communication technologies, the examples provided herein may be similarly applied to various other radio communication technologies, both existing and not yet formulated, particularly in cases where such radio communication technologies share similar features as disclosed regarding the following examples. Various exemplary radio communication technologies that the apparatuses and methods described herein may utilize include, but are not limited to: a Global System for Mobile Communications (“GSM”) radio communication technology, a General Packet Radio Service (“GPRS”) radio communication technology, an Enhanced Data Rates for GSM Evolution (“EDGE”) radio communication technology, and/or a Third Generation Partnership Project (“3GPP”) radio communication technology, for example Universal Mobile Telecommunications System (“UMTS”), Freedom of Multimedia Access (“FOMA”), 3GPP Long Term Evolution (“LTE”), 3GPP Long Term Evolution Advanced (“LTE Advanced”), Code division multiple access 2000 (“CDMA2000”), Cellular Digital Packet Data (“CDPD”), Mobitex, Third Generation (3G), Circuit Switched Data (“CSD”), High-Speed Circuit-Switched Data (“HSCSD”), Universal Mobile Telecommunications System (“Third Generation”) (“UMTS (3G)”), Wideband Code Division Multiple Access (Universal Mobile Telecommunications System) (“W-CDMA (UMTS)”), High Speed Packet Access (“HSPA”), High-Speed Downlink Packet Access (“HSDPA”), High-Speed Uplink Packet Access (“HSUPA”), High Speed Packet Access Plus (“HSPA+”), Universal Mobile Telecommunications System-Time-Division Duplex (“UMTS-TDD”), Time Division-Code Division Multiple Access (“TD-CDMA”), Time Division-Synchronous Code Division Multiple Access (“TD-CDMA”), 3rd Generation Partnership Project Release 8 (Pre-4th Generation) (“3GPP Rel. 8 (Pre-4G)”), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17), 3GPP Rel. 18 (3rd Generation Partnership Project Release 18), 3GPP 5G, 3GPP LTE Extra, LTE-Advanced Pro, LTE Licensed-Assisted Access (“LAA”), MuLTEfire, UMTS Terrestrial Radio Access (“UTRA”), Evolved UMTS Terrestrial Radio Access (“E-UTRA”), Long Term Evolution Advanced (4th Generation) (“LTE Advanced (4G)”), cdmaOne (“2G”), Code division multiple access 2000 (Third generation) (“CDMA2000 (3G)”), Evolution-Data Optimized or Evolution-Data Only (“EV-DO”), Advanced Mobile Phone System (1st Generation) (“AMPS (1G)”), Total Access Communication arrangement/Extended Total Access Communication arrangement (“TACS/ETACS”), Digital AMPS (2nd Generation) (“D-AMPS (2G)”), Push-to-talk (“PTT”), Mobile Telephone System (“MTS”), Improved Mobile Telephone System (“IMTS”), Advanced Mobile Telephone System (“AMTS”), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (“Autotel/PALM”), ARP (Finnish for Autoradiopuhelin, “car radio phone”), NMT (Nordic Mobile Telephony), High capacity version of NTT (Nippon Telegraph and Telephone) (“Hicap”), Cellular Digital Packet Data (“CDPD”), Mobitex, DataTAC, Integrated Digital Enhanced Network (“iDEN”), Personal Digital Cellular (“PDC”), Circuit Switched Data (“CSD”), Personal Handy-phone System (“PHS”), Wideband Integrated Digital Enhanced Network (“WiDEN”), iBurst, Unlicensed Mobile Access (“UMA”), also referred to as also referred to as 3GPP Generic Access Network, or GAN standard), Zigbee, Bluetooth®, Wireless Gigabit Alliance (“WiGig”) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p and other) Vehicle-to-Vehicle (“V2V”) and Vehicle-to-X (“V2X”) and Vehicle-to-Infrastructure (“V2I”) and Infrastructure-to-Vehicle (“I2V”) communication technologies, 3GPP cellular V2X, DSRC (Dedicated Short Range Communications) communication arrangements such as Intelligent-Transport-Systems, and other existing, developing, or future radio communication technologies.

The apparatuses and methods described herein may use such radio communication technologies according to various spectrum management schemes, including, but not limited to, dedicated licensed spectrum, unlicensed spectrum, (licensed) shared spectrum (such as LSA=Licensed Shared Access in 2.3-2.4 GHz, 3.4-3.6 GHz, 3.6-3.8 GHz and further frequencies and SAS=Spectrum Access System in 3.55-3.7 GHz and further frequencies), and may use various spectrum bands including, but not limited to, IMT (International Mobile Telecommunications) spectrum (including 450-470 MHz, 790-960 MHz, 1710-2025 MHz, 2110-2200 MHz, 2300-2400 MHz, 2500-2690 MHz, 698-790 MHz, 610-790 MHz, 3400-3600 MHz, etc., where some bands may be limited to specific region(s) and/or countries), IMT-advanced spectrum, IMT-2020 spectrum (expected to include 3600-3800 MHz, 3.5 GHz bands, 700 MHz bands, bands within the 24.25-86 GHz range, etc.), spectrum made available under FCC's “Spectrum Frontier” 5G initiative (including 27.5-28.35 GHz, 29.1-29.25 GHz, 31-31.3 GHz, 37-38.6 GHz, 38.6-40 GHz, 42-42.5 GHz, 57-64 GHz, 64-71 GHz, 71-76 GHz, 81-86 GHz and 92-94 GHz, etc.), the ITS (Intelligent Transport Systems) band of 5.9 GHz (typically 5.85-5.925 GHz) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHz) and WiGig Band 4 (63.72-65.88 GHz), the 70.2 GHz-71 GHz band, any band between 65.88 GHz and 71 GHz, bands currently allocated to automotive radar applications such as 76-81 GHz, and future bands including 94-300 GHz and above. Furthermore, the apparatuses and methods described herein can also employ radio communication technologies on a secondary basis on bands such as the TV White Space bands (typically below 790 MHz) where e.g. the 400 MHz and 700 MHz bands are prospective candidates. Besides cellular applications, specific applications for vertical markets may be addressed such as PMSE (Program Making and Special Events), medical, health, surgery, automotive, low-latency, drones, etc. applications. Furthermore, the apparatuses and methods described herein may also use radio communication technologies with a hierarchical application, such as by introducing a hierarchical prioritization of usage for different types of users (e.g., low/medium/high priority, etc.), based on a prioritized access to the spectrum e.g., with highest priority to tier-1 users, followed by tier-2, then tier-3, etc. users, etc. The apparatuses and methods described herein can also use radio communication technologies with different Single Carrier or OFDM flavors (CP-OFDM, SC-FDMA, SC-OFDM, filter bank-based multicarrier (FBMC), OFDMA, etc.) and e.g. 3GPP NR (New Radio), which can include allocating the OFDM carrier data bit vectors to the corresponding symbol resources.

For purposes of this disclosure, radio communication technologies may be classified as one of a Short Range radio communication technology or Cellular Wide Area radio communication technology. Short Range radio communication technologies may include Bluetooth, WLAN (e.g., according to any IEEE 802.11 standard), and other similar radio communication technologies. Cellular Wide Area radio communication technologies may include Global System for Mobile Communications (“GSM”), Code Division Multiple Access 2000 (“CDMA2000”), Universal Mobile Telecommunications System (“UMTS”), Long Term Evolution (“LTE”), General Packet Radio Service (“GPRS”), Evolution-Data Optimized (“EV-DO”), Enhanced Data Rates for GSM Evolution (“EDGE”), High Speed Packet Access (HSPA; including High Speed Downlink Packet Access (“HSDPA”), High Speed Uplink Packet Access (“HSUPA”), HSDPA Plus (“HSDPA+”), and HSUPA Plus (“HSUPA+”)), Worldwide Interoperability for Microwave Access (“WiMax”) (e.g., according to an IEEE 802.16 radio communication standard, e.g., WiMax fixed or WiMax mobile), etc., and other similar radio communication technologies. Cellular Wide Area radio communication technologies also include “small cells” of such technologies, such as microcells, femtocells, and picocells. Cellular Wide Area radio communication technologies may be generally referred to herein as “cellular” communication technologies.

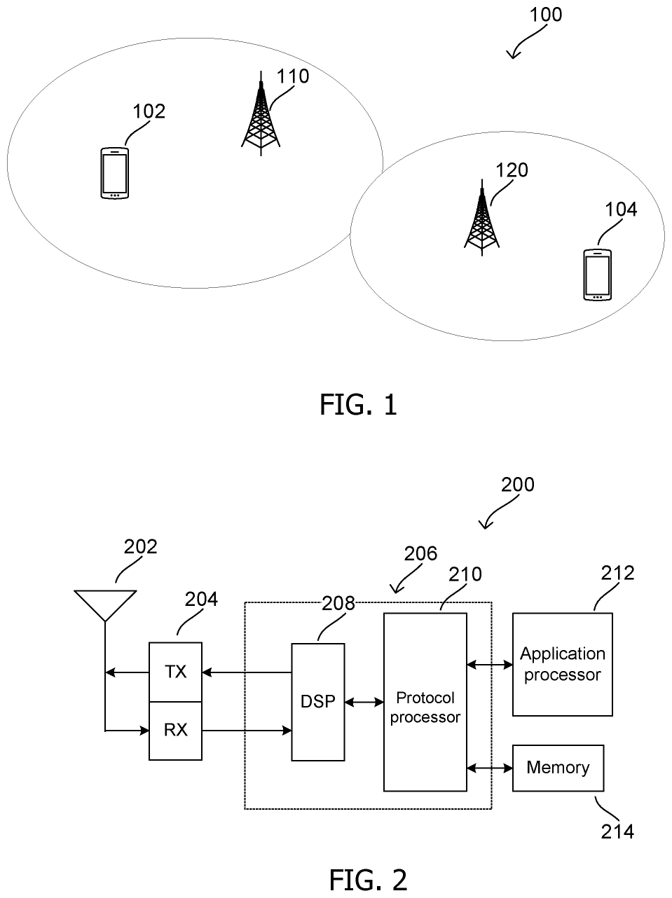

FIGS. 1 and 2 depict a general network and device architecture for wireless communications. In particular, FIG. 1 shows exemplary radio communication network 100 according to some aspects, which may include terminal devices 102 and 104 and network access nodes 110 and 120. Radio communication network 100 may communicate with terminal devices 102 and 104 (i.e. mobile radio communication devices) via network access nodes 110 and 120 (i.e. radio communication devices) over a radio access network. Although certain examples described herein may refer to a particular radio access network context (e.g., LTE, UMTS, GSM, other 3rd Generation Partnership Project (3GPP) networks, WLAN/WiFi, Bluetooth, 5G NR, mmWave, etc.), these examples are demonstrative and may therefore be readily applied to any other type or configuration of radio access network. The number of network access nodes and terminal devices in radio communication network 100 is exemplary and is scalable to any amount.

In an exemplary cellular context, network access nodes 110 and 120 may be base stations (e.g., eNodeBs, NodeBs, Base Transceiver Stations (BTSs), gNodeBs, or any other type of base station), while terminal devices 102 and 104 may be cellular terminal devices (e.g., Mobile Stations (MSs), User Equipments (UEs), or any type of cellular terminal device). Network access nodes 110 and 120 may therefore interface (e.g., via backhaul interfaces) with a cellular core network such as an Evolved Packet Core (EPC, for LTE), Core Network (CN, for UMTS), or other cellular core networks, which may also be considered part of radio communication network 100. The cellular core network may interface with one or more external data networks. In an exemplary short-range context, network access node 110 and 120 may be access points (APs, e.g., WLAN or WiFi APs), while terminal device 102 and 104 may be short range terminal devices (e.g., stations (STAs)). Network access nodes 110 and 120 may interface (e.g., via an internal or external router) with one or more external data networks. Network access nodes 110 and 120 and terminal devices 102 and 104 may include one or multiple transmission/reception points (TRPs).

Network access nodes 110 and 120 (and, optionally, other network access nodes of radio communication network 100 not explicitly shown in FIG. 1) may accordingly provide a radio access network to terminal devices 102 and 104 (and, optionally, other terminal devices of radio communication network 100 not explicitly shown in FIG. 1). In an exemplary cellular context, the radio access network provided by network access nodes 110 and 120 may enable terminal devices 102 and 104 to wirelessly access the core network via radio communications. The core network may provide switching, routing, and transmission, for traffic data related to terminal devices 102 and 104, and may further provide access to various internal data networks (e.g., control nodes, routing nodes that transfer information between other terminal devices on radio communication network 100, etc.) and external data networks (e.g., data networks providing voice, text, multimedia (audio, video, image), and other Internet and application data). In an exemplary short-range context, the radio access network provided by network access nodes 110 and 120 may provide access to internal data networks (e.g., for transferring data between terminal devices connected to radio communication network 100) and external data networks (e.g., data networks providing voice, text, multimedia (audio, video, image), and other Internet and application data).

The radio access network and core network (if applicable, such as for a cellular context) of radio communication network 100 may be governed by communication protocols that can vary depending on the specifics of radio communication network 100. Such communication protocols may define the scheduling, formatting, and routing of both user and control data traffic through radio communication network 100, which includes the transmission and reception of such data through both the radio access and core network domains of radio communication network 100. Accordingly, terminal devices 102 and 104 and network access nodes 110 and 120 may follow the defined communication protocols to transmit and receive data over the radio access network domain of radio communication network 100, while the core network may follow the defined communication protocols to route data within and outside of the core network. Exemplary communication protocols include LTE, UMTS, GSM, WiMAX, Bluetooth, WiFi, mmWave, etc., any of which may be applicable to radio communication network 100.

FIG. 2 shows an exemplary internal configuration of a communication device according to various aspects provided in this disclosure. The communication device may include various aspects of radio communication devices (e.g. network access nodes 110, 120) or various aspects of mobile radio communication devices (e.g. terminal device 102, 104) as well. The communication device 200 may include antenna system 202, radio frequency (RF) transceiver 204, baseband modem 206 (including digital signal processor 208 and protocol controller 210), application processor 212, and memory 214. Although not explicitly shown in FIG. 2, in some aspects communication device 200 may include one or more additional hardware and/or software components, such as processors/microprocessors, controllers/microcontrollers, other specialty or generic hardware/processors/circuits, peripheral device(s), memory, power supply, external device interface(s), subscriber identity module(s) (SIMs), user input/output devices (display(s), keypad(s), touchscreen(s), speaker(s), external button(s), camera(s), microphone(s), etc.), or other related components.

Communication device 200 may transmit and receive radio signals on one or more radio access networks. Baseband modem 206 may direct such communication functionality of communication device 200 according to the communication protocols associated with each radio access network, and may execute control over antenna system 202 and RF transceiver 204 to transmit and receive radio signals according to the formatting and scheduling parameters defined by each communication protocol. Although various practical designs may include separate communication components for each supported radio communication technology (e.g., a separate antenna, RF transceiver, digital signal processor, and controller), for purposes of conciseness the configuration of communication device 200 shown in FIG. 2 depicts only a single instance of such components.

Communication device 200 may transmit and receive wireless signals with antenna system 202. Antenna system 202 may be a single antenna or may include one or more antenna arrays that each include multiple antenna elements. For example, antenna system 202 may include an antenna array at the top of communication device 200 and a second antenna array at the bottom of communication device 200. In some aspects, antenna system 202 may additionally include analog antenna combination and/or beamforming circuitry. In the receive (RX) path, RF transceiver 204 may receive analog radio frequency signals from antenna system 202 and perform analog and digital RF front-end processing on the analog radio frequency signals to produce digital baseband samples (e.g., In-Phase/Quadrature (IQ) samples) to provide to baseband modem 206. RF transceiver 204 may include analog and digital reception components including amplifiers (e.g., Low Noise Amplifiers (LNAs)), filters, RF demodulators (e.g., RF IQ demodulators)), and analog-to-digital converters (ADCs), which RF transceiver 204 may utilize to convert the received radio frequency signals to digital baseband samples. In the transmit (TX) path, RF transceiver 204 may receive digital baseband samples from baseband modem 206 and perform analog and digital RF front-end processing on the digital baseband samples to produce analog radio frequency signals to provide to antenna system 202 for wireless transmission. RF transceiver 204 may thus include analog and digital transmission components including amplifiers (e.g., Power Amplifiers (PAs), filters, RF modulators (e.g., RF IQ modulators), and digital-to-analog converters (DACs), which RF transceiver 204 may utilize to mix the digital baseband samples received from baseband modem 206 and produce the analog radio frequency signals for wireless transmission by antenna system 202. In some aspects baseband modem 206 may control the radio transmission and reception of RF transceiver 204, including specifying the transmit and receive radio frequencies for operation of RF transceiver 204.

As shown in FIG. 2, baseband modem 206 may include digital signal processor 208, which may perform physical layer (PHY, Layer 1) transmission and reception processing to, in the transmit path, prepare outgoing transmit data provided by protocol controller 210 for transmission via RF transceiver 204, and, in the receive path, prepare incoming received data provided by RF transceiver 204 for processing by protocol controller 210. Digital signal processor 208 may be configured to perform one or more of error detection, forward error correction encoding/decoding, channel coding and interleaving, channel modulation/demodulation, physical channel mapping, radio measurement and search, frequency and time synchronization, antenna diversity processing, power control and weighting, rate matching/de-matching, retransmission processing, interference cancelation, and any other physical layer processing functions. Digital signal processor 208 may be structurally realized as hardware components (e.g., as one or more digitally-configured hardware circuits or FPGAs), software-defined components (e.g., one or more processors configured to execute program code defining arithmetic, control, and I/O instructions (e.g., software and/or firmware) stored in a non-transitory computer-readable storage medium), or as a combination of hardware and software components. In some aspects, digital signal processor 208 may include one or more processors configured to retrieve and execute program code that defines control and processing logic for physical layer processing operations. In some aspects, digital signal processor 208 may execute processing functions with software via the execution of executable instructions. In some aspects, digital signal processor 208 may include one or more dedicated hardware circuits (e.g., ASICs, FPGAs, and other hardware) that are digitally configured to specific execute processing functions, where the one or more processors of digital signal processor 208 may offload certain processing tasks to these dedicated hardware circuits, which are known as hardware accelerators. Exemplary hardware accelerators can include Fast Fourier Transform (FFT) circuits and encoder/decoder circuits. In some aspects, the processor and hardware accelerator components of digital signal processor 208 may be realized as a coupled integrated circuit.

Communication device 200 may be configured to operate according to one or more radio communication technologies. Digital signal processor 208 may be responsible for lower-layer processing functions (e.g., Layer 1/PHY) of the radio communication technologies, while protocol controller 210 may be responsible for upper-layer protocol stack functions (e.g., Data Link Layer/Layer 2 and/or Network Layer/Layer 3). Protocol controller 210 may thus be responsible for controlling the radio communication components of communication device 200 (antenna system 202, RF transceiver 204, and digital signal processor 208) in accordance with the communication protocols of each supported radio communication technology, and accordingly may represent the Access Stratum and Non-Access Stratum (NAS) (also encompassing Layer 2 and Layer 3) of each supported radio communication technology. Protocol controller 210 may be structurally embodied as a protocol processor configured to execute protocol stack software (retrieved from a controller memory) and subsequently control the radio communication components of communication device 200 to transmit and receive communication signals in accordance with the corresponding protocol stack control logic defined in the protocol software. Protocol controller 210 may include one or more processors configured to retrieve and execute program code that defines the upper-layer protocol stack logic for one or more radio communication technologies, which can include Data Link Layer/Layer 2 and Network Layer/Layer 3 functions. Protocol controller 210 may be configured to perform both user-plane and control-plane functions to facilitate the transfer of application layer data to and from radio communication device 200 according to the specific protocols of the supported radio communication technology. User-plane functions can include header compression and encapsulation, security, error checking and correction, channel multiplexing, scheduling and priority, while control-plane functions may include setup and maintenance of radio bearers. The program code retrieved and executed by protocol controller 210 may include executable instructions that define the logic of such functions.

Communication device 200 may also include application processor 212 and memory 214. Application processor 212 may be a CPU, and may be configured to handle the layers above the protocol stack, including the transport and application layers. Application processor 212 may be configured to execute various applications and/or programs of communication device 200 at an application layer of communication device 200, such as an operating system (OS), a user interface (UI) for supporting user interaction with communication device 200, and/or various user applications. The application processor may interface with baseband modem 206 and act as a source (in the transmit path) and a sink (in the receive path) for user data, such as voice data, audio/video/image data, messaging data, application data, basic Internet/web access data, etc. In the transmit path, protocol controller 210 may therefore receive and process outgoing data provided by application processor 212 according to the layer-specific functions of the protocol stack, and provide the resulting data to digital signal processor 208. Digital signal processor 208 may then perform physical layer processing on the received data to produce digital baseband samples, which digital signal processor may provide to RF transceiver 204. RF transceiver 204 may then process the digital baseband samples to convert the digital baseband samples to analog RF signals, which RF transceiver 204 may wirelessly transmit via antenna system 202. In the receive path, RF transceiver 204 may receive analog RF signals from antenna system 202 and process the analog RF signals to obtain digital baseband samples. RF transceiver 204 may provide the digital baseband samples to digital signal processor 208, which may perform physical layer processing on the digital baseband samples. Digital signal processor 208 may then provide the resulting data to protocol controller 210, which may process the resulting data according to the layer-specific functions of the protocol stack and provide the resulting incoming data to application processor 212. Application processor 212 may then handle the incoming data at the application layer, which can include execution of one or more application programs with the data and/or presentation of the data to a user via a user interface.

Memory 214 may embody a memory component of communication device 200, such as a hard drive or another such permanent memory device. Although not explicitly depicted in FIG. 2, the various other components of communication device 200 shown in FIG. 2 may additionally each include integrated permanent and non-permanent memory components, such as for storing software program code, buffering data, etc.

In accordance with various aspects provided herein, at least one of baseband modem 206 or application processor 212 may perform processing to provide aspects disclosed herein. For example, for a mobile radio communication device, at least one of baseband modem 206 or application processor 212 may generate and encode reference signals for transmission to a radio communication device. Alternatively, for example, for a radio communication device, baseband modem 206 (or application processor 212) may receive radio signal, and at least one of baseband modem 206 or application processor 212 may perform channel estimations as described in this disclosure, and configure radio communication operations based on performed channel estimations.

In accordance with some radio communication networks, terminal devices 102 and 104 may execute mobility procedures to connect to, disconnect from, and switch between available network access nodes of the radio access network of radio communication network 100. As each network access node of radio communication network 100 may have a specific coverage area, terminal devices 102 and 104 may be configured to select and re-select available network access nodes in order to maintain a strong radio access connection with the radio access network of radio communication network 100. For example, terminal device 102 may establish a radio access connection with network access node 110 while terminal device 104 may establish a radio access connection with network access node 112. In the event that the current radio access connection degrades, terminal devices 102 or 104 may seek a new radio access connection with another network access node of radio communication network 100; for example, terminal device 104 may move from the coverage area of network access node 112 into the coverage area of network access node 110. As a result, the radio access connection with network access node 112 may degrade, which terminal device 104 may detect via radio measurements such as signal strength or signal quality measurements of network access node 112. Depending on the mobility procedures defined in the appropriate network protocols for radio communication network 100, terminal device 104 may seek a new radio access connection (which may be, for example, triggered at terminal device 104 or by the radio access network), such as by performing radio measurements on neighboring network access nodes to determine whether any neighboring network access nodes can provide a suitable radio access connection. As terminal device 104 may have moved into the coverage area of network access node 110, terminal device 104 may identify network access node 110 (which may be selected by terminal device 104 or selected by the radio access network) and transfer to a new radio access connection with network access node 110. Such mobility procedures, including radio measurements, cell selection/reselection, and handover are established in the various network protocols and may be employed by terminal devices and the radio access network in order to maintain strong radio access connections between each terminal device and the radio access network across any number of different radio access network scenarios.

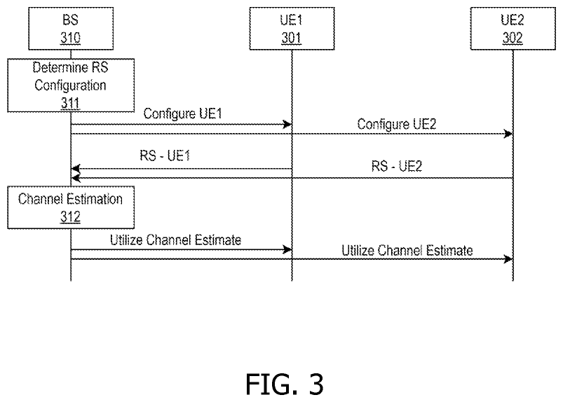

FIG. 3 shows an exemplary illustration of a channel estimation procedure for multiple mobile radio communication devices within a radio access network. It is to be appreciated as various aspects are described illustratively in accordance with cellular networks in a constellation that mobile radio communication devices are illustrated as UEs 301, 302, radio communication device is illustrated as a BS 310, and the channel estimation procedure may be exemplified as an SRS procedure. However, aspects described herein may similarly apply to other type of radio access networks, some of which are described in this disclosure. BS 310 may illustratively be an evolved node-B (eNB) or a next generation node-B (gNB). In a disaggregated radio communication architecture (e.g. Open-Radio Access Network (O-RAN)), the BS 310 may include a distributed unit (e.g. O-DU) and a radio unit (e.g. O-RU) (i.e. depending on the designated split of the protocol stack).

Initially, the BS 310 may configure reference signals (e.g. Sounding Reference Signals (SRS)) and certain aspects of the procedure. A processor of the BS 310 may determine 311 reference signal (RS) configurations. This configuration may include a range of critical parameters, including periodicity of RS the assignment of RS physical resources, determination of RS usage patterns, and precise timing for reporting RS data. It is to be noted that the BS 310 may determine at least some of these parameters based on the conditions of the cell (e.g. cell load, UE locations, etc.) and data traffic requirements. The BS 310 may configure the UEs 301, 302 through dedicated Radio Resource Control (RRC) messages, such as RRCSetup and RRCReconfiguration. Although it is illustrated here, as the BS 310 seems to configure UE1 301 and UE2 302 around same time period, this is not essential, and each configuration is temporally independent. Illustratively, the BS 310 may configure both UE1 301 and UE2 302 to transmit RS for the same time and frequency resources. UE1 301 and UE2 302 respectively configure their radio communication operations to perform the RS procedure according to the configuration indicated by the BS 310.

Based on their respective configurations, each of UE1 301 and UE2 302 may transmit respective RSs. The BS 310 is aware of the characteristics of each RS transmitted by UE1 301 and UE2 302. Illustratively, RSs are SRSs and the BS 310 may store information representative of the reference signals. UE1 301 may transmit its respective RS at its respective radio communication resources configured by the BS 310. Similarly, UE2 302 may also transmit its respective RS at its respective radio communication resources. In some examples, UE1 301 and UE2 302 may transmit their respective RS, which overlap at least for one or more time and/or frequency resources.

Illustratively, UE1 301 and UE2 302 may transmit their respective RS at the same time and frequency resources. Alternatively, UE1 301 may transmit its respective RS within first subcarriers of a plurality of subcarriers at one or more OFDM symbols and UE2 302 may transmit its respective RS within second subcarriers of the plurality of subcarriers at the same one or more OFDM symbols. In some examples, each subcarrier of the first subcarriers may be consecutive to one subcarrier of the second subcarriers.

Exemplifying RS as SRS, it is to be noted that each UE 301, 302 may transmit the respective SRS periodically according to its respective configuration or aperiodically based on a received indication from the BS 310. Each transmission may be across the full frequency band or across designated subcarriers of the frequency band of the uplink channel, as configured by the BS 310. In an example with partial overlap of frequency resources between SRSs transmitted by UE1 301 and UE2 302, at least one subcarrier includes both SRS of UE1 301 and SRS of UE2 302 at the same time resources.

The BS 310 may receive the RSs of both UE1 301 and UE2 302 as radio communication signals, which may overlap at least one time and frequency resources (e.g. at a resource element). The BS 310 may perform 312 a channel estimation to estimate the channel of UE1 301 (i.e. channel between the BS 310 and UE1 301) and the channel of UE2 302 (channel between the BS 310 and UE1 301). perform measurements and analyze received radio communication signals. The purpose of the channel estimation is to obtain channel information for each of the channel of UE1 301 and the channel of UE2 302, representative of the respective channel. For SRS, the obtained channel information may be referred to as channel state information (CSI). For this purpose, the BS 310 may obtain received RSs of each UE1 301 and UE2 302, and compare the received RS of each UE 301, 302 with a respective known RS previously determined for the respective UE 301, 302. The performed channel estimation may include evaluation of certain parameters, such as strength of the received signal, path loss and/or propagation delay estimations, etc.

It is to be noted that, in scenarios involving multiple mobile radio communication devices, as described illustratively herein with UE1 301 and UE2 302, the BS 310 may be confronted with the challenge of managing and distinguishing between the RSs transmitted by respective UEs 301, 302. This distinction is vital for accurate channel estimation and subsequent utilization of channel estimates to optimize radio communication. Although various examples are described within this disclosure, the BS 310 may perform any conventional methods to extract the received RS of UE1 301 and the received RS of UE 2 302.

Once the BS 310 has performed channel estimation, the BS 310 may utilize the channel estimate for the channel of UE1 301 and the channel estimate for the channel of UE2 302 for radio communication (e.g. uplink communication) with UE1 301 and UE2 302 respectively. Utilization of the channel estimates may include resource allocation and/or scheduling based on the channel estimates; adjusting transmission parameters of the respective UEs, such as modulation and coding schemes (MCS), adjusting MIMO parameters, etc. In some examples, the BS 310 may use the channel estimate of a respective UE to determine transmit symbols of the respective UE.

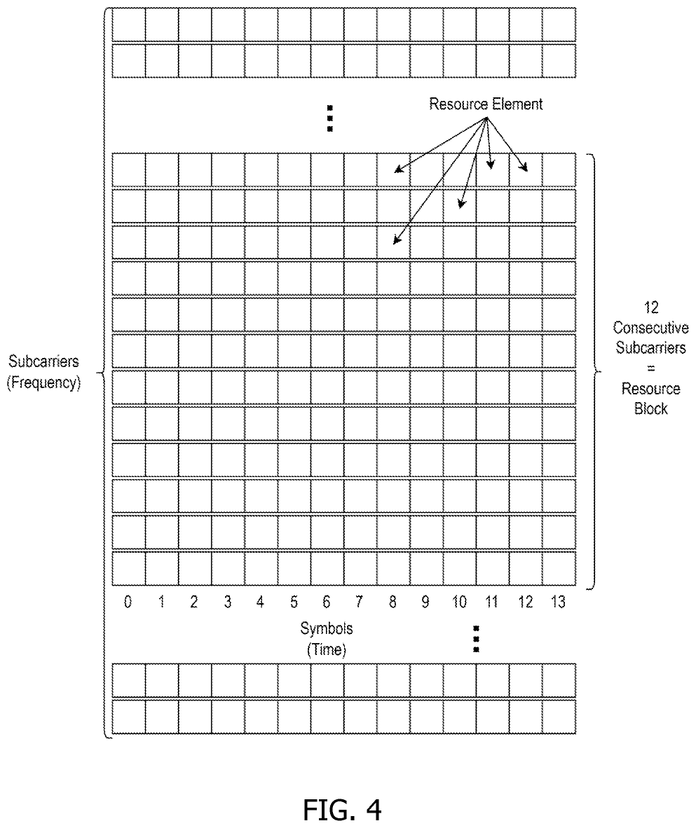

FIG. 4 shows an exemplary illustration of a resource grid for radio communication, complimenting the resource grid of LTE/5G. The resource grid represents time and frequency resources to perform radio communication, exemplarily in a radio access network. The smallest element corresponding to one time and frequency resource may be referred to as a resource element. Illustratively, in 5G/NR a resource element corresponds to one subcarrier during one OFDM symbol.

A resource block may be defined as 12 consecutive subcarriers in the frequency domain. It is to be considered that, resource block may sometimes be referred to as a physical resource block. To describe time domain limitations of a resource block, further considerations may be made, but minimum time domain length of a resource block can be one OFDM symbol duration. Consecutive 14 OFDM symbols may be referred to as a slot.

In accordance with various aspects provided herein, the BS 310 may configure each UE 301, 302, within the same frequency band and within the same OFDM symbols. The number of OFDM symbols may illustratively be one symbol, two symbols, four symbols, etc., and each UE 301, 302 may map its respective SRS to respective subcarriers designated for the respective UE 301, 302. Illustratively, in a comb 2 configuration, a UE may map its SRS to every 2^{nd} subcarrier (e.g. at subcarriers 0, 2, 4, 6, 8, 10 of a resource block) within a designated frequency band (e.g. within a number of resource blocks). Similarly, in a comb 4 configuration, a UE may map its SRS to every 4^{th} subcarrier (e.g. at subcarriers 0, 4, 8 of a resource block) within a designated frequency band (e.g. within a number of resource blocks). Illustratively, in the comb 4 configuration, the BS 310 may configure UE1 301 to transmit SRS using subcarriers 0, 4, 8 at one or more OFDM symbols, and the BS 310 may configure UE2 302 to transmit SRS using subcarriers 1, 5, 9 at the same one or more OFDM symbols. Accordingly, transmitted SRS of UE1 301 and UE2 302 overlaps at the one or more OFDM symbols.

A UE may encode reference signals within the phase of a reference waveform (sometimes may be referred to as reference signal, reference sequence, or a base sequence). In other words, an encoded RS may include cyclically shifted versions of a predetermined reference sequence (e.g. based on a Zadoff-Chu sequence). The UE may map the cyclically shifted version of a predetermined reference sequence to its respective time and frequency resources as configured by BS. Each UE may apply a corresponding cyclic shift. The BS being aware of the applied cyclic shift and further parameters used by the UE to generate the RS may reproduce the same RS.

More precisely RS signal generation may include, using an example of SRS generation, using a base sequence. The base sequence may be represented as r_{u,v}^{(α)}=e^{jαn}r_{u,v}(n), n denoting a designated length of RS sequence, u denoting a designated base sequence group number and v denoting the sequence number within the group for certain cases. An RS signal of a UE may be defined by a cyclic shift α assigned to the UE and the base sequence. Applied cyclic shift α in the time domain is equivalent to a phase rotation in the frequency domain. The sequence r itself may be a Zadoff-Chu sequence, due to its constant power in time and frequency, or a designated quadrature phase shift keying (QPSK) sequence for this purpose.

It is further to be noted that in various aspects provided in this disclosure, a transmit RS may refer to a RS transmitted by a mobile radio communication device. A received or a receive RS may refer to an RS received by a radio communication device. In a modelling of a radio communication channel using the mathematical equation of y=hx+n, y h being the channel response and n being additive noise (e.g. additive gaussian white noise), y may include the receive RS and x may correspond to the transmit RS.

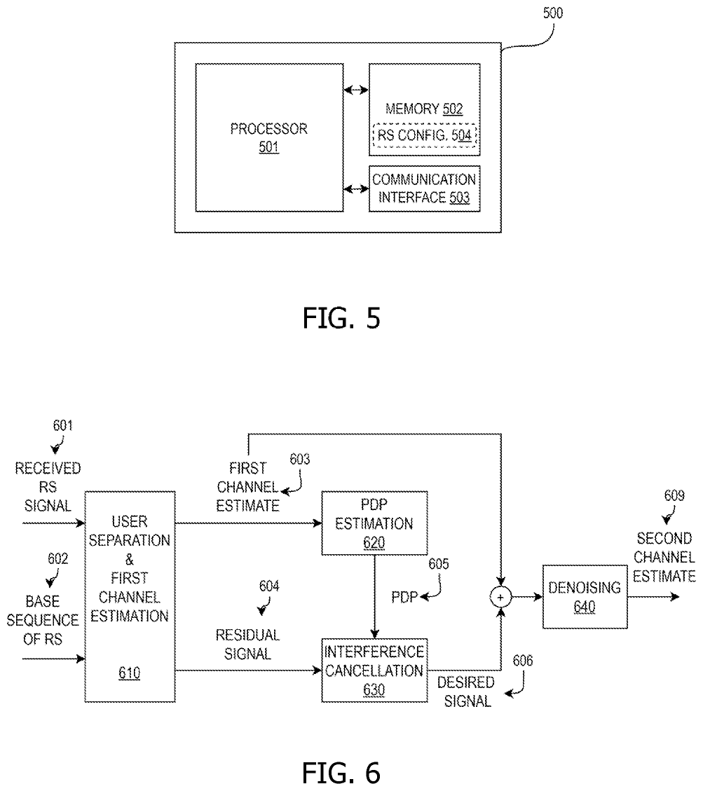

FIG. 5 shows an example of an apparatus of a radio communication device according to various examples in this disclosure. The radio communication device 500 may be a radio communication device (e.g. the BS 310) of a mobile radio communication network, which the radio communication device 500 may be configured to receive radio communication signals from a plurality of mobile radio communication devices (e.g. UE1 301, UE2 302). In cellular communication context, the radio communication device 500 may be a BS (e.g. an evolved node-B (eNB), a next generation node-B (gNB). In a disaggregated radio communication architecture (e.g. Open-Radio Access Network (O-RAN)), the radio communication device 500 may include a distributed unit (e.g. O-DU) or a radio unit (e.g. 0-RU) (i.e. depending on the designated split of the protocol stack).

The apparatus 500 may include a processor 501, a memory 502, and a communication interface 503 configured to receive and transmit communication signals in order to communicate with further entities (i.e. the plurality of mobile radio communication devices) within the mobile communication network. In some aspects, the communication interface 503 may include one or more signal paths to carry communication signals. The communication interface 503 may include one or more transceivers.

In some examples, the communication interface 503 may be configured for beamforming and/or MIMO communication, and thereby may include a plurality of signal paths. Correspondingly, the transceiver included by the communication interface 503 may be a MIMO transceiver including an antenna interface configured to connect to multiple antennas (e.g. to a MIMO array). In some examples, the apparatus 500 may be configured for performing a frequency hopping operation and the communication interface 503 may further configured for the frequency hopping operation.

The processor 501 may include one or more processors, which may include a baseband processor and an application processor (e.g. application processor 212, baseband modem 206). In various examples, the processor 501 may include a central processing unit (CPU), a graphics processing unit (GPU), a hardware acceleration unit (e.g. one or more dedicated hardware accelerator circuits (e.g., ASICs, FPGAs, and other hardware)), a neuromorphic chip, and/or a controller. The processor 501 may be implemented in one processing unit, e.g. a system on chip (SOC), or a processor. In accordance with various examples, the processor 501 may further provide further functions to process received communication signals. The memory 502 may store various types of information required for the processor 501, or the communication interface 503 to operate in accordance with various aspects of this disclosure.

The memory 502 may be configured to store, among other things, information 504 representative of channel estimation procedure involving the radio communication device 500. Illustratively, the information 504 may include RS configuration, such as a range of critical parameters associated with channel estimation procedure involving RSs of the plurality of mobile radio communication devices, including periodicity of RS for each mobile radio communication device, the assignment of RS physical resources for each mobile radio communication device, determination of RS usage patterns for each mobile radio communication device, and precise timing for reporting RS data. In particular, the information may include information representative of a corresponding RS expected from each mobile radio communication device. RS information may include any type of information which the radio communication device 500 may obtain the transmit RS signal sent by each mobile radio communication device, such as the signal itself, or a base sequence and various parameters (e.g. cyclic shifts assigned to each mobile radio communication device) based on which the radio communication device 500 may reproduce the transmit RS signal.

It is to be noted that the radio communication device 500 may have associated according to any known methods with the plurality of mobile radio communication devices. Illustratively, the radio communication device 500 may have established connections with each mobile radio communication device of the plurality of mobile radio communication devices. Within cellular communication context, the established connections may include RRC connections, and the radio communication device 500 may have configured the channel estimation procedure through RRC configurations.

The processor 501 may be configured to perform channel estimations based on one or more channel estimation methods. Illustratively, one or more antennas connected to the radio communication device 500 may receive radio communication signals sent by multiple mobile radio communication devices. RF circuits connected to the one or more antennas may transform received radio communication signals into baseband signals, along with other operations including amplification, refinement, etc. Accordingly, the processor 501 may obtain baseband signals obtained from the received radio communication signals. The processor 501 may further provide digital front-end processing to the baseband signals to refine received baseband signals. The processor 501 may perform channel estimations based on the one or more channel estimation methods on the baseband signals.

In a multi-user scenario, considering that the received radio communication signals include respective radio communication signals of each mobile radio communication device of the plurality of mobile communication devices, the processor 501 may separate the respective signals (e.g. baseband signals) of each mobile radio communication device. In some aspects, the respective signals for each mobile radio communication device may be referred to as a user signal. Within the context of RSs, the respective signals for each mobile radio communication device may be referred to as a user RS. It is to be noted that the user RS indicated here with yᵤ(t) corresponds to a received RS from u-th mobile radio communication device. xᵤ(t) on the other hand, corresponds to a transmit RS of the u-th mobile radio communication device. Illustratively, at a given time slot, N mobile radio communication devices have been transmitted, a received baseband signal may be formulated as provided below, y denoting the baseband signal, hᵤ denoting channel response (e.g. channel coefficients) of the user u, xᵤ denoting the user signal (e.g. transmit user RS), n(t) denoting noise, and τᵤ denoting the delay associated with the user u:

$$y ( t ) = {\sum }_{u = 0}^{N - 1} {y}_{u} ( t ) = {\sum }_{u = 0}^{N - 1} {h}_{u} {x}_{u} ( t - {τ}_{u} ) + n ( t )$$

Although there are specific examples provided in this disclosure for user separation (i.e. separating xᵤ from y(t) for each mobile radio communication device) to obtain user signals, some of which may be employed due to orthogonal nature of transmitted RSs, the processor 501 may perform any conventional user separation methods to obtain respective user signals of the mobile radio communication devices.

The processor 501 may perform a plurality of channel estimations for the received radio communication signal, such that each channel estimation is performed to estimate the channel of one of the mobile radio communication devices. Referring to the above-mentioned formulation of the received baseband signal and yᵤ being the received user RS of the respective u-th mobile radio communication device, the processor 501 may perform channel estimations for each mobile radio communication device to estimate the respective hᵤ. The processor 501 may perform the channel estimation for u-th user to estimate the respective hᵤ based on the received user RS (i.e. yᵤ) of the u-th user. In various aspects described herein, the output of each performed channel estimation for the respective hᵤ may be referred to as a user channel estimate.

Furthermore, the processor 501 may determine a residual signal that is common to the mobile radio communication devices which have transmitted their respective RSs. For this purpose, the processor 501 may calculate the residual signal based on a combination of all user channel estimate and user RS pairs. More precisely, denoting the output of channel estimation as user channel estimate of u-th mobile radio communication device as [symbol] , and the transmit RS of the u-th mobile radio communication device xᵤ, the processor 501 may calculate the residual signal based on [symbol] and xᵤ combinations of the plurality of mobile radio communication devices. The processor 501 may use the information 504 stored in the memory 502 to determine each xᵤ for the mobile radio communication devices. In some examples, the processor 501 may determine the residual signal yᵣₑₛ(t) according to the mathematical formulation:

$${y}_{res} ( t ) = y ( t ) - {\sum }_{u = 0}^{N - 1} {x}_{u} ( t )$$

The processor 501 may further perform at least one further channel estimation to determine channel information for at least one of the channels of one of the mobile radio communication devices based on the residual signal an estimated PDP of that channel. Illustratively, the processor 501 may determine, for u-th mobile radio communication device, a h̅ᵤ̅ based on yᵣₑₛ(t) and the estimated PDP of the channel of the u-th mobile radio communication device. The processor 501 may use the estimated PDP of the that channel in a further channel estimation method to optimize the [symbol] . In various aspects, the processor 501 may perform an interference cancellation using [symbol] .

The processor 501 may perform further channel estimations. Each further channel estimation may be to determine respective channel information of the channel of the respective mobile radio communication devices. Each further channel estimation may be based on the residual signal and an estimated PDP of the corresponding channel of the respective mobile radio communication device. The processor 501 may use the estimated PDP of the corresponding previously estimated channel (i.e. with the first channel estimation) to optimize the corresponding previously estimated channel using the estimated PDP. In various aspects, the processor 501 may perform the interference cancellation in a manner that is specific to the previously estimated channel of the respective mobile radio communication device.

In accordance with various aspects provided herein, the processor 501 may perform denoising. In various examples, the processor 501 may apply a Linear Minimum Mean Squared Error (LMMSE) filter to obtain the channel information of the channels of the mobile radio communication devices. In other words, the further channel estimation may include an application of an LMMSE filter. By applying the LMMSE filter, the processor 701 may reduce noise and interference that may corrupt the estimated channel characteristics that is output of the interference cancellation and the first channel estimation. Through the denoising the processor 501 may improve the accuracy of the channel information to be used for communication and remove unwanted distortions.

Broadly, the LMMSE filter may provide its function by minimizing the mean squared error between the estimated channel and the true channel response. In this illustrative [symbol] example, the processor 501 may use the first channel estimate u, and a desired signal (i.e. a reference signal; an interference cancelled receive user RS) for the input of the LMMSE filter. The processor 501 may, for the LMMSE filter function, provide an output as the channel information for the respective channel according to the first channel estimate and the statistical properties of the noise in the received signal. The processor 501 may, for the LMMSE filter function, analyze these inputs to create a weighted combination that optimally denoises the first channel estimate. The processor 501 may, for the LMMSE filter function, output a refined channel estimate that is an output of the further channel estimation for the respective channel.

In accordance with various aspects provided herein, the processor 501 may be configured to estimate a time offset of a received user RS of the respective mobile radio communication device. In some examples, the processor 501 may estimate the time offset based on the estimated PDP, exemplarily using the PDP values obtained with the PDP estimation. Through the PDP estimation, the processor 501 may obtain information about delays associated with interfering signals, and the processor 501 may perform a time domain interference cancellation as the interference cancellation based on these delays. Illustratively, the processor 501 may perform a time offset correction based on the delays associated with the interfering signals (e.g. time delays estimated with the PDP estimation having peaks below a threshold or peaks that are not maximum peaks) to align multipath components of the interference signals correctly with the received signal.

FIG. 6 shows an exemplary illustration of a block diagram to describe various aspects of the channel estimation in separate units. A processor (e.g. the processor 501) may implement the aspects described herein. A user separation unit 610 may separate a respective RS of each mobile radio communication device of a plurality of mobile radio communication devices from a received communication signal (e.g. baseband signal) including RSs of the mobile radio communication devices. It is to be noted that the operation may involve receiving radio communication signals mapped to corresponding subcarriers of the frequency band for each mobile radio communication device. It is further to be noted that aspects are illustrated herein for SRSs as RSs received from UEs.

An SRS (i.e. received RS 601) received in the k-th SRS-allocated subcarrier in each receive antenna of the radio communication device (e.g. the apparatus 500) may be denoted as below, in which where Hᵤ(k) is the channel of the u-th UE, Xᵤ(k) is the SRS symbol transmitted by the u-th UE, Z(k) is additive white Gaussian noise (AWGN), and k=0, . . . , N_{SRS}−1; N_{SRS} being number of SRS symbols designated for corresponding SRS transmission:

$$Y ( k ) = {\sum }_{u = 0}^{N - 1} {H}_{u} ( k ) {X}_{u} ( k ) + Z ( k )$$

The user separation unit 610 may further obtain the corresponding base sequence 602 associated with the received RS 601. Illustratively, SRS symbols transmitted by the UEs are orthogonal Zadoff-Chu sequence or a sequence that is orthogonal and based on Zadoff-Chu sequence. Illustratively, for a bandwidth of 16 physical resource blocks and comb 4 configuration, up to 12 UEs can transmit their respective SRS symbols that are orthogonal every 12 subcarriers. It is to be noted that various aspects are described for such a scenario and the skilled person would be aware of modifications for different scenarios. The user separation unit 610 may further be configured to obtain a first channel estimate 603 for each UE and a residual signal 604 that is common for the UEs.

In accordance with various aspects, the user separation unit 610 may include one or more matched filters (MF). Considering the orthogonality of the SRS symbols within the presence of multiple UEs, the application of the MF may decimate the channel of each UE by the sequence length required for orthogonality. In the scenario described above, with the application of the MF with corresponding parameters, the output of the MF may include one channel value per UE every 12 subcarriers. It is to be noted that various aspects of the user separation unit 610 has been illustrated with the MF, however the user separation unit 610 within this context may include further conventional methods, such as ZF precoding.

In other words, the processor may apply the MF to the received RSs to extract the respective RS of each UE. The MF may be configured for a reference sequence with a designated sequence length for orthogonality between received RSs. Illustratively, the application of the MF may include, for each UE, a dot product between the received RSs and the complex conjugate transpose of the respective user RS (i.e. SRS symbol transmitted by the respective UE), which may be formulated as:

$${\hat{H}}_{u}^{( MF )} = {X}_{u , s}^{H} Y$$

It is to be noted from the sub index u of Ĥᵤ^{(MF)} that the processor may obtain multiple first channel estimates for multiple UEs, such that each first channel estimate 603 is representative of a channel estimate output of the MF for a respective UE of multiple UEs. Although there are common elements, such as received RS 601, received base sequence 602, and the residual signal, which are common for channel estimations of the UEs, the block diagram and operations described herein intends to describe obtaining a second channel estimation 609 of one of the UEs, which may be used to obtain second channel estimations for the UEs (e.g. UEs using corresponding SRS time and frequency resources).

The user separation unit 610 may further include a linear interpolator, or in other words, the processor may apply a linear interpolation to outputs of the MF. It is to be considered that with the application of the MF, outputs of the MF may include a channel value for each UE at intervals equal to the sequence length (e.g. every 12 subcarriers in case of 12 UE). It order to obtain a more continuous and fine-grained estimate of the channel response over the entire SRS bandwidth, which may be used to determine the residual signal, the processor may apply the linear interpolation. In other examples, the processor may apply other interpolation methods to obtain a channel estimate over the entire SRS bandwidth that is based on respective outputs of the MF for the UEs. The output of the linear interpolator may be formulated as below, Ĥᵤ^{(Lin)}(k) denoting the output of linear interpolation for u-th UE, slopeᵤ denoting the slope of the respective channel of the u-th UE within each 12 subcarriers segment, and k_{c} denoting the center frequency:

$${\hat{H}}_{u}^{( Lin )} ( k ) = {slope}_{u} * ( k - {k}_{c} ) + {\hat{H}}_{u}^{( MF )}$$

The processor may further calculate the residual signal 604 based on the output of the interpolator and the received RS 601. A residual signal may be considered to represent the discrepancy or error between estimated channel characteristics and actual channel conditions. The processor may obtain the residual signal based on the difference between the received RSs and the output of the interpolator, the output representing the estimate channel response over the entire SRS bandwidth according to the output of the first channel estimate (i.e. MF), which may be formulated as:

$${Y}_{res} ( k ) = Y ( k ) - {\sum }_{u = 0}^{N - 1} {\hat{H}}_{u}^{( Lin )} ( k ) {X}_{u} ( k )$$

A PDP estimation unit 620 (e.g. a PDP estimator) may receive the first channel estimate associated with the channel of the respective UE as input to estimate the PDP of the channel of the respective UE. Illustratively, the PDP estimation unit 620 may output 605, for each first channel estimate, information representative of the intensity (e.g. average power) of the received user RS in terms of the received delay with respect to an arrival path (e.g. a first arrival path) in multi-path transmission. As an example, the PDP estimation unit 620 may receive the output of linear interpolation for the first channel estimate of the respective UE to obtain corresponding estimate PDP values 605 for the respective UE, which is to be denoted as Pu 605.

The processor may implement any conventional methods to obtain Pu 605 for each UE. In accordance with various aspects provided herein, the processor may implement a trained neural network to obtain Pu 605. In particular, the trained neural network may be a domain knowledge enhanced neural network (DKE NN) to incorporate domain-specific expertise and knowledge, as the first channel estimates 603 may be highly decimated and contaminated and a robust PDP estimator may improve the accuracy considering the inaccuracies of the first channel estimates 603. In some examples, the trained neural network may perform its inference to output PDP values 605 based on received input of the first channel estimates 603 for each antenna of the radio communication device. Exemplarily, the neural network was trained using a supervised training methods, illustratively by providing coarse channel estimates with known PDP estimates (e.g. using conventional methods) and adjusting model parameters (e.g. weights, biases, etc.) to map the input coarse channel estimates to the respective PDP estimates with a conventional error function (e.g. mean square error; i.e. adjusting parameters to minimize the error). Various aspects of such a trained neural network is described separately in this disclosure.

In some examples, an interference cancellation unit 630 may receive the residual signal 604 and the PDP 605 of the respective UE to extract an interference cancelled received RS 606 of the respective UE. It is to be noted that this example is illustrated in a manner that it includes the interference cancellation unit 630 which is optional. In some examples, the PDP estimation unit 620 may provide the PDP(s) for the first channel estimate(s) to the denoising unit 640. In some examples, the interference cancellation unit 630 may be configured to perform a time-domain interference cancellation. In some examples, the interference cancellation unit 630 may be configured to perform a frequency-domain interference cancellation. The output of the interference cancellation unit 630 may include a desired signal 606, that is being the received RS of the respective UE to which the corresponding interference cancellation is applied, which sometimes is referred to as an interference cancelled received RS of the respective UE.

It is to be noted that the residual signal 604 includes respective desired signals of the UEs, however each desired signal of a respective UE may be contaminated by interference of other UEs. The interference cancellation unit 630 may extract a respective desired signal for a respective UE based on time domain taps of the respective UE. For this purpose, the processor may perform an N_{SRS}-point inverse discrete Fourier transform to extract the time domain taps associated with the respective UE, which may be formulated as below, noting that the first Mᵤ≤N_{SRS} taps contain the desired signal of the u-th user (i.e. \tilde{α}ᵤ=\tilde{α}ᵤ(0:Mᵤ−1):

$${\tilde{α}}_{u} ( τ ) = IDFT ( {X}_{u}^{*} ( k ) {Y}_{res} ( k ) )$$

It is to be noted that each set of time domain taps \tilde{α}ᵤ(τ) for u-th UE may represent how the received RS from the respective UE is distributed over time. Considering that each set of time domain taps may be representative of temporal characteristics of the received user RS within the received RS, the processor may select the first Mᵤ taps from the respective set of time domain taps for the respective UE. The processor may identify the first Mᵤ taps from the respective set of time domain taps for the respective UE based on the PDP 605 of the respective UE. In some examples, the PDP estimation 620 may be configured to output RMS delay spread based on the estimated PDP of the respective channel of the respective UE. In some examples, the processor may calculate an RMS delay spread based on the PDP 605. The processor may calculate the RMS delay spread according to the mathematical formula, for the respective PDP of the UE, pᵢ denoting the power of the i-th path, τᵢ is the delay of the i-th path and τ̅ denoting the mean delay:

$${τ}_{rms} = \sqrt{\frac{{\sum }_{i} {{p}_{i} ( {τ}_{i} - \overline{τ} )}^{2}}{{\sum }_{i} {p}_{i}}}$$

Accordingly, by extracting the respective desired signal for the respective UE, the processor may optimize the first channel estimate of the respective UE according to extracted respective desired signal for the respective UE. In some examples, the processor may calculate an SNR with a ratio of the respective desired signal and an estimated noise. The processor may use the linearly interpolated version of the first channel estimate, namely Ĥᵤ^{(Lin)}(k), to obtain an interference cancelled channel estimate for the channel of the respective UE by adding a discrete Fourier transform (DFT) applied to the extracted respective desired signal, which can be denoted as the following:

$${\hat{H}}_{u}^{( IC )} ( k ) = {\hat{H}}_{u}^{( Lin )} ( k ) + DFT ( {{α}^{⌣}}_{u} )$$

Ĥᵤ^{(IC)} may denote the interference cancelled channel estimate for the channel of the u-th UE. It is to be noted that in accordance with various aspects provided in this disclosure, the second channel estimate may include Ĥᵤ^{(IC)}. In other words, the output of the second channel estimation may be Ĥᵤ^{(IC)}. Alternatively speaking, Ĥᵤ^{(IC)} may be an estimated channel information for the respective u-th UE from the UEs based on the residual signal and the estimate PDP of the channel of the respective u-th UE. Although, a denoising unit 640 is provided in this illustrative example, in examples in which the denoising unit 640 is not provided, the second channel estimates 609 may include Ĥᵤ^{(IC)}.

The denoising unit 640 may obtain the interference cancelled channel estimate for the channel of the respective UE to denoise the interference cancelled channel estimate. In some examples, the denoising unit 640 may include an LMMSE filter. The processor may apply the LMMSE filter to denoise Ĥᵤ^{(IC)}(k) and accordingly obtain the second channel estimate 609. In some examples, the processor may apply the LMMSE filter based on predetermined LMMSE filter coefficients, which may include generation of LMMSE filter parameters offline using quantized PDP and SNR values correspondingly. In some examples, the processor may determine the LMMSE filter coefficients based on the PDP 605 for channel of the respective UE and an estimated signal to noise ratio (SNR) for the received RS of the respective UE.

In accordance various aspects herein, the processor may utilize a trained neural network (NN) to perform PDP estimations for each UE, (i.e. obtain the PDP 605). The processor may implement the NN. According to various aspects of this disclosure, other types of NN implementations may include a further processor that may be internal or external to the processor (e.g. an accelerator, a graphics processing unit (GPU), a neuromorphic chip, etc.), and/or a memory may also implement the NN. The NN may be configured to provide output data based on input data and NN parameters (i.e. model parameters). The NN may include a trained NN, in which the NN parameters have been configured according to a training process for the purpose of providing estimate PDP values for a channel based on received input data including information representative of a channel response of the channel (e.g. channel values, a channel vector, a channel matrix, etc.).

A trained NN may include an NN, which is trained prior to an inference to obtain output data. In various aspects, NN parameters include parameters configured to control how input data is transformed into output data. NN parameters may further include hyperparameters configured to control how the AI/ML performs learning (e.g. learning rate, number of layers, classifiers, etc.). In order to implement the trained NN, the processor may include an NN unit. The NN unit may receive the input data representative of a channel estimate of a channel of a UE. In various examples, the processor may provide the input data with an input format suitable for the respective NN (e.g. compatible input feature vectors) so that the NN may process the input data.

The NN may be any type of artificial neural network. The NN may include any number of layers, including an input layer to receive the input data, an output layer to provide the output data. A number of layers may be provided between the input layer and the output layer (e.g. hidden layers). The training of the NN (e.g., adapting the layers of the neural network, adjusting NN parameters) may use or may be based on any kind of training principle, such as backpropagation (e.g., using the backpropagation algorithm). For example, the NN may be a feed-forward NN in which the information is transferred from lower layers of the NN close to the input to higher layers of the NN close to the output. Each layer may include neurons that receive input from a previous layer and provide an output to a next layer based on certain NN (e.g. weights, biases) parameters adjusting the input information.

The NN may include a recurrent neural network in which neurons transfer the information in a configuration in which the neurons may transfer the input information to a neuron of the same layer. Recurrent neural networks (RNNs) may help to identify patterns between a plurality of input sequences, and accordingly, RNNs may be used to identify, in particular, a temporal pattern provided with time-series data and perform estimations based on the identified temporal patterns. In various examples of RNNs, long short-term memory (LSTM) architecture may be implemented. The LSTM networks may be helpful to perform classifications, processing, and estimations using time series data.

An LSTM network may include a network of LSTM cells that may process the attributes provided for an instance of time as input data, such as attributes provided the instance of time, and one or more previous outputs of the LSTM that have taken in place in previous instances of time, and accordingly, obtain the output data. The number of the one or more previous inputs may be defined by a window size, and the weights associated with each previous input may be configured separately. The window size may be arranged according to the processing, memory, and time constraints and the input data. The LSTM network may process the features of the received raw data and determine a label for an attribute for each instance of time according to the features. The output data may include or represent a label associated with the input data.

In various examples, the NN may be configured in top-down configuration in which a neuron of a layer provides output to a neuron of a lower layer, which may help to discriminate certain features of an input.

The AI/ML may include a convolutional neural network (CNN), which is an example for feed-forward neural networks that may be used for the purpose of this disclosure, in which one or more of the hidden layers of the neural network include one or more convolutional layers that perform convolutions for their received input from a lower layer. The CNNs may be helpful for pattern recognition and classification operations. The CNN may further include pooling layers, fully connected layers, and normalization layers.

The AI/ML may include a generative neural network. The generative neural network may process input data in order to generate new sets, hence the output data may include new sets of data according to the purpose of the AI/ML. In various examples, the AI/ML may include a generative adversarial network (GAN) model in which a discrimination function is included with the generation function, and while the generation function may generate the data according to model parameters of the generation function and the input data, the discrimination function may distinguish the data generated by the generation function in terms of data distribution according to model parameters of the discrimination function. In accordance with various aspects of this disclosure, a GAN may include a deconvolutional neural network for the generation function and a CNN for the discrimination function.

The NN may include a trained NN that is configured to provide the output as provided in various examples in this disclosure based on the input data and one or more NN parameters obtained by the training. The trained NN may be obtained via an online and/or offline training. A training agent may perform various operations with respect to the training at various aspects, including online training, offline training, and optimizations based on the inference results. The NN may take any suitable form or utilize any suitable technique for training process. For example, the NN may be trained using supervised learning, semi-supervised learning, unsupervised learning, or reinforcement learning techniques.

In supervised learning, the NN may be obtained using a training set of data including both inputs and corresponding desired outputs (illustratively, input data may be associated with a desired or expected output for that input data). Each training instance may include one or more input data item and a desired output. The training agent may train the NN based on iterations through training instances and using an objective function to teach the NN to estimate the output for new inputs (illustratively, for inputs not included in the training set). In semi-supervised learning, a portion of the inputs in the training set may be missing the respective desired outputs (e.g., one or more inputs may not be associated with any desired or expected output).

In unsupervised learning, the model may be built from a training set of data including only inputs and no desired outputs. The unsupervised model may be used to find structure in the data (e.g., grouping or clustering of data points), illustratively, by discovering patterns in the data. Techniques that may be implemented in an unsupervised learning model may include, e.g., self-organizing maps, nearest-neighbor mapping, k-means clustering, and singular value decomposition.

Reinforcement learning models may include positive feedback (also referred to as reward) or negative feedback to improve accuracy. A reinforcement learning model may attempt to maximize one or more objectives/rewards. Techniques that may be implemented in a reinforcement learning model may include, e.g., Q-learning, temporal difference (TD), and deep adversarial networks.

The training agent may adjust the NN parameters based on outputs and inputs (i.e. output data and input data). The training agent may train the NN according to the desired outcome. The training agent may provide the training data to the NN to train the NN. For example, the training input data may include, or may be based on, training channel estimates generated or obtained to represent various states of radio communication channels between UEs and a BS. The training channel estimates may include information representative of one or more attributes designated to represent various conditions of a channel. Training data may further include training output data associated with the training input data representing desired outcomes concerning each set of training input data. Illustratively, the training output data includes estimate PDP values for the channel corresponding to the respective training input data. Training output data may indicate, or may represent, the desired outcome with respect to training input data, so that the training agent may provide necessary adjustments to respective NN parameters in consideration of the desired outcome.

For example, the NN is configured to receive input data including a coarse channel estimate (i.e. a first channel estimate, illustratively an output of a MF), and to provide output data that is representative of a predetermined PDP for the respective channel. Accordingly, each training data set may include a training input data representative of a coarse channel estimate, and a training output data representative of estimated PDP values. In some examples, the NN is configured to receive input data including an interference cancelled channel estimate (i.e. an optimized channel estimate, illustratively an output of the interference cancellation unit 630), and to provide output data that is representative of a predetermined PDP for the respective channel. By inferencing for each training input data, the training agent may adjust the NN parameters of the NN based on a mapped output by the NN and the training output data based on an objective function. In various aspects provided herein, the objective function may be a mathematical function (i.e. a mapping operation that maps parameters to, for example, a value) based on performance metrics (i.e. predicted performance metrics and observed performance metrics) such as a loss function or a reward function.

In other words, the training agent may train the NN by providing training input data to the input of the NN and it may adjust NN parameters of the NN based on the output of the NN and training output data associated with the provided training input data with an intention to make the output of the NN more accurate. Accordingly, the training agent may adjust one or more NN parameters based on a calculation including parameters for the output of the NN for the training input data and the training output data associated with the training input data. With each iteration with respect to the training input data that may include many data items, which each data item may represent an input of an instance (of time, of observation, etc.) on various aspects and each iteration may iterate a respective data item representing an input of an instance, the training agent may accordingly cause the NN to provide more accurate output through adjustments made in the NN parameters.

In particular within the context of DKE NNs, the training of the NN may particularly include incorporating domain-specific knowledge into the NN and then fine-tuning its parameters using domain-relevant data. Aspects may particularly include, by the training agent, to identify and gather domain-specific knowledge, rules, constraints, or insights that can enhance the network's performance in the target domain and to transform this knowledge into a form that can be integrated into the NN. This could involve creating additional input features, designing custom layers, or defining loss functions that reflect domain-specific objectives. Domain affecting factors for the DKE NN may include, in this context, the radio communication technology used to carry RSs, RS characteristics (e.g. SRS, DM-RS, etc.), statistical model of channels, expected cross-interference levels, etc. In some examples, training of the DKE NN may include initializing NN parameters randomly or with pre-trained weights, depending on the architecture, and correspondingly using backpropagation and an optimization algorithm (e.g., stochastic gradient descent) to update the network's parameters iteratively, computing, during each training iteration, gradients based on the defined loss function and backpropagating them through the NN to adjust the NN parameters (e.g. weights). Accordingly, the NN may learn to make estimations that align with the domain knowledge and minimize the overall loss function.

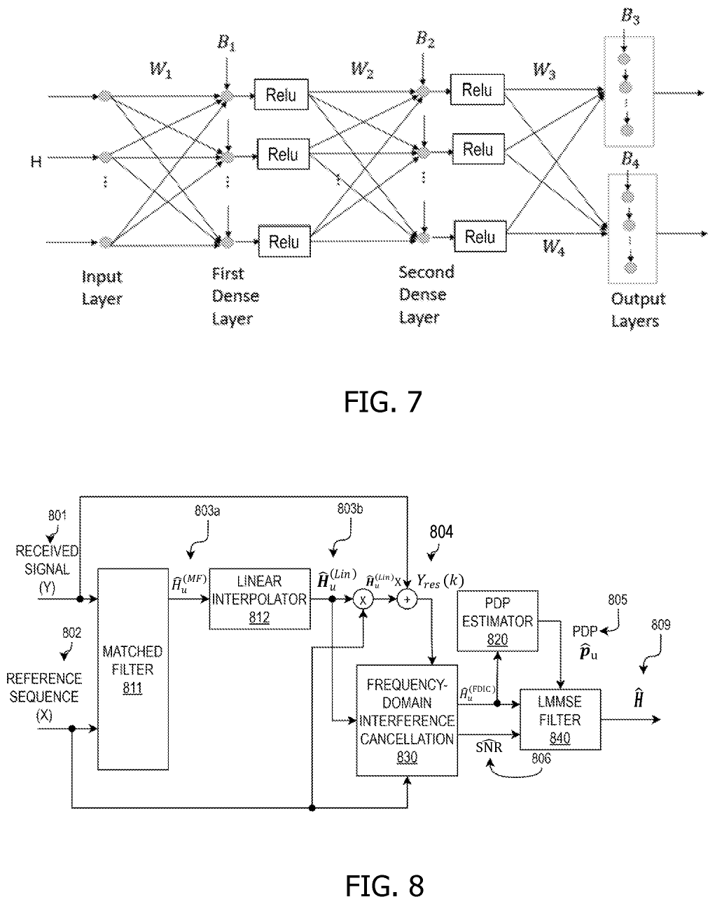

FIG. 7 shows an example of an NN in accordance with various aspects provided herein. A processor (e.g. the processor 501) may implement a DKE NN as a PDP estimator. In some examples, the PDP estimator may provide its corresponding output per antenna. The processor may then aggregate, for a respective channel of a respective mobile radio communication device, inferences over multiple antennas to obtain the PDP estimation. Denoting the mapping (i.e. transformation) of the DKE NN to the input data including the first channel estimate (e.g. linearly interpolated MF output) with DKENN, the output of the DKE NN may be denoted as:

$${\hat{p}}_{u} = DKENN ( {\hat{H}}_{u}^{( Lin )} )$$

As indicated above, in some examples, the DKE NN may be configured to estimate PDP of a channel based on an interference cancelled channel estimate of the respective channel. Analogous to the formulation described above, this exemplary implementation may be denoted with, noting that Ĥᵤ^{(Lin)}(k)+Xᵤ*(k)Yᵣₑₛ(k) represents Ĥᵤ^{(IC)}(k):

$${\hat{p}}_{u} = DKENN ( {\hat{H}}_{u}^{( Lin )} ( k ) + {X}_{u}^{*} ( k ) {Y}_{res} ( k ) )$$

In some aspects, the optimization of the NN may be subjected to a form of constraints which may be represented using Lagrange Multipliers. The NN may learn, during the training, to map the input data to Lagrange Multipliers to optimize corresponding NN parameters. In some examples, the NN may be configured to provide the estimate PDP from first output layers and provide a Lagrange Multiplier from second output layers to optimize at least the data output of the first output layers. In some examples, the Lagrange Multiplier may be of a maximum likelihood estimation of the PDP estimates based on the input data.

In this figure, it has been illustrated that the DKE NN may receive channel estimate values represented with input feature vector H from the input layers. The input layers may map the input feature vector based on first set of NN weights W1 to a first dense layer. An activation function such as a ReLu may be performed on the nodes of the first dense layer before they are passed with associated weights to a second dense layer. Nodes of the second layer may also be treated with an activation function, ReLu, and information may then directed to output layers with certain values representative of weight.

It is to be noted that as the radio communication device may employ multiple antennas to communicate with the UEs, inference intended for the respective mobile radio communication device may be based on all antennas, or a subset of antennas. The processor may determine the subset of antennas, illustratively based on received signal strength. As each inference of the NN may be based on a channel estimate based on received signals using one antenna, the processor may calculate an average of output from all inferences for the respective mobile radio communication device over the subset of the antennas in which activation function is invoked only once per a mobile radio communication device from multiple radio communication devices, which can be denoted using the mathematical formula:

$$\overline{Z} = \frac{1}{{N}_{Ant}} {\sum }_{iAnt} Z$$

$$and ,$$

$$\overline{V} = \frac{1}{{N}_{Ant}} {\sum }_{iAnt} V$$

$$\overline{Z} = \frac{1}{{N}_{Ant}} {\sum }_{iAnt} Z$$

$$and ,$$

$$\overline{V} = \frac{1}{{N}_{Ant}} {\sum }_{iAnt} V$$

In other words, the processor may obtain output data by collecting data from output layers of multiple inferences, each per antenna associated with the respective mobile radio communication device, and averaging over the total number of antennas such that Z is input to a suitable activation function such as softmax to provide PDP output as:

$$PDP = \frac{{e}^{{\overline{Z}}_{k}}}{{\sum }_{l} {e}^{{\overline{Z}}_{l}}}$$

FIG. 8 shows an exemplary block diagram of a channel estimation in accordance with various aspects provided herein. A processor (e.g. the processor 501) may perform the channel estimation. It is to be noted that similar features are shown in particular to compliment the aspects described in accordance with FIG. 6. Features that are similar to the aspects described in FIG. 6 have been numbered with a similar reference numeral in a manner that only the first numeral of the references are different (e.g. 601 corresponds to 801, 630 corresponds to 830, etc.). It is to be noted that similar features are to be structured similarly, operate similarly, and/or have the same function unless otherwise explicitly indicated.

In this exemplary block diagram, the channel estimation may include a frequency domain interference cancellation 830 as an interference cancellation unit (e.g. the interference cancellation unit 630). In some examples, the processor may determine to bypass the time-domain interference cancellation, which the interference cancellation unit may perform. Furthermore, in this example, a user separation unit may be illustrated as it includes a matched filter 811 and a linear interpolator 812. A received radio signal Y 801 including a plurality of RSs of a plurality of mobile radio communication devices may input to a matched filter 811. The matched filter 811 may further receive the reference sequence X 802 associated with at least one mobile radio communication device from the plurality of mobile radio communication devices, of which a channel of the respective mobile radio communication device is to be estimated. Exemplarily, the processor may perform the aspects to estimate channels for each mobile radio communication device of the plurality of mobile communication devices.

The reference sequence X 802 may include an expected RS from the respective mobile radio communication device (i.e. a cyclically shifted reference sequence to which an assigned cyclic shift of the respective mobile radio communication device is applied). The matched filter 811 may compute a correlation of inputs to determine a channel estimate Ĥᵤ^{(MF)} 803a for the respective mobile radio communication device. To provide a channel estimate over the entire bandwidth of the received signal Y, the channel estimate Ĥᵤ^{(MF)} 803b may be fed into the linear interpolator 812. The linear interpolator 812 may interpolate the channel values included into Ĥᵤ^{(MF)} to obtain a linearly interpolated channel estimate for the respective mobile radio communication device Ĥᵤ^{(Lin)} 803b.

The processor may further obtain a residual signal for the plurality of mobile radio communication devices. For this purpose, the linearly interpolated channel estimate for the respective mobile radio communication device Ĥᵤ^{(Lin)} 803b is multiplied with the reference sequence X to obtain Ĥᵤ^{(Lin)}X. In some aspects obtained linearly interpolated channel estimates for all mobile radio communication devices are accumulated and the residual signal Yᵣₑₛ(k) 804 may be obtained by calculating the difference of the accumulation from the received signal Y. The frequency domain interference cancellation unit 830 may perform an frequency domain interference cancellation based on the residual signal Yᵣₑₛ(k) 804, the linearly interpolated channel estimate of the respective mobile radio communication device Ĥᵤ^{(Lin)} 803b, and the reference sequence X of the respective mobile radio communication device to obtain an interference cancelled channel estimate Ĥᵤ^{(FDIC)}. The output of the frequency domain interference cancellation unit 830 may further include an SNR estimate 806 of the estimated desired signal. The PDP estimator may obtain PDP values 805 based on PDP estimation of the interference cancelled channel estimate Ĥᵤ^{(FDIC)}, and output the PDP values 805 to the LMMSE filter 840. The processor may configure LMMSE filter coefficients of the LMMSE filter 840 based on the SNR estimate 806 and the PDP values 805 to optimize the Ĥᵤ^{(FDIC)} and obtain a final channel estimate Ĥ as the channel information representative of the channel of the respective mobile radio communication device u.

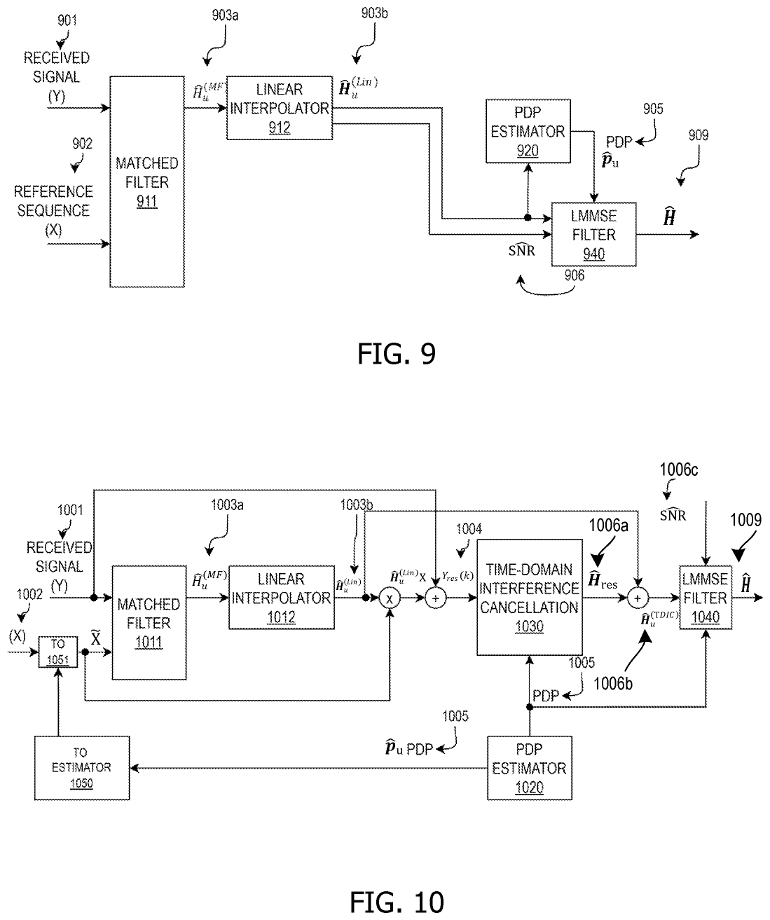

FIG. 9 shows an exemplary block diagram of a channel estimation in accordance with various aspects provided herein. A processor (e.g. the processor 501) may perform the channel estimation. It is to be noted that similar features are shown in particular to compliment the aspects described in accordance with FIG. 6. Features that are similar to the aspects described in FIG. 6 have been numbered with a similar reference numeral in a manner that only the first numeral of the references are different (e.g. 601 corresponds to 901, 630 corresponds to 930, etc.). It is to be noted that similar features are to be structured similarly, operate similarly, and/or have the same function unless otherwise explicitly indicated.

In this exemplary block diagram, the channel estimation may include no interference cancellation (i.e. no interference cancellation unit 630). In some examples, the processor may determine to bypass the interference cancellation, which the interference cancellation unit may perform. Furthermore, in this example, a user separation unit may be illustrated as it includes a matched filter 911 and a linear interpolator 912. In some alternative examples, the user separation unit may include a ZF precoder to obtain a first channel estimate at least for the respective mobile radio communication device, and optionally for other mobile radio communication devices. A received radio signal Y 901 including a plurality of RSs of a plurality of mobile radio communication devices may input to a matched filter 911. The matched filter 911 may further receive the reference sequence X 902 associated with at least one mobile radio communication device from the plurality of mobile radio communication devices, of which a channel of the respective mobile radio communication device is to be estimated. Exemplarily, the processor may perform these aspects to estimate channels for each mobile radio communication device of the plurality of mobile communication devices.

The reference sequence X 902 may include an expected RS from the respective mobile radio communication device (i.e. a cyclically shifted reference sequence to which an assigned cyclic shift of the respective mobile radio communication device is applied). The matched filter 911 may compute a correlation of inputs to determine a channel estimate Ĥᵤ^{(MF)} 903a for the respective mobile radio communication device. To provide a channel estimate over the entire bandwidth of the received signal Y, the channel estimate Ĥᵤ^{(MF)} 903b may be fed into the linear interpolator 912. The linear interpolator 912 may interpolate the channel values included into Ĥᵤ^{(MF)} to obtain a linearly interpolated channel estimate for the respective mobile radio communication device Ĥᵤ^{(Lin)} 903b.

The processor may further obtain a residual signal at least for the respective mobile radio communication device to determine the desired signal for the respective mobile radio communication device and accordingly provide an SNR estimate 906 of the estimated desired signal to the LMMSE filter 940. The PDP estimator may obtain PDP values 905 based on PDP estimation of the linearly interpolated channel estimate for the respective mobile radio communication device Ĥᵤ^{(Lin)} 903b, and output the PDP values 905 to the LMMSE filter 940. The processor may configure LMMSE filter coefficients of the LMMSE filter 940 based on the SNR estimate 906 and the PDP values 905 to optimize the Ĥᵤ^{(Lin)} 903b and obtain a final channel estimate Ĥ as the channel information representative of the channel of the respective mobile radio communication device u.

In accordance with various aspects provided herein including LMMSE filters, a processor (e.g. the processor 501) may determine LMMSE filter coefficients to obtain a channel estimate for a channel based at least partially on estimated PDP (i.e. PDP values) of the channel and estimate SNR associated with the desired signal received via the channel. It is to be noted that the estimate PDP of the channel may indicate how the channel is estimated to attenuate transmit signals at different time delays, which may involve an impulse response of the channel and the multipath characteristics. Illustratively, while a longer delay may imply a slower propagation path, a higher power level may indicate a stronger signal component. Further, the SNR may indicate a quality of the received signal to noise and interference.

In an illustrative scenario in which the PDP may indicate two taps with different power levels (i.e. one for direct path and one for a delayed signal) and the SNR may indicate a good SNR level, the processor may initially normalize the PDP, such that sum of the power levels may equal to 1. In some aspects, the processor may calculate the LMMSE filter coefficients to minimize mean square error, based on a calculated covariance (e.g. covariance matrix) of the PDP and the SNR. The processor may calculate the LMMSE filter coefficients according to the mathematical formula below, R(p) denoting the covariance matrix of the PDP, and ω denoting LMMSE filter coefficients, I denoting an inverse matrix:

$$ω = {( R ( p ) + \frac{1}{SNR} I )}^{- 1} R ( p )$$

FIG. 10 shows an exemplary block diagram of a channel estimation in accordance with various aspects. In this illustrative example, the channel estimation may include a time domain interference cancellation unit and a time offset correction unit. In this constellation, the time domain interference cancellation unit, with the involvement of time offset correction, may reduce or cancel interference by aligning multipath components of the interference signals correctly according to a time offset \hat{τ} determined based on the PDP estimation. A processor (e.g. the processor 501) may perform the channel estimation. This example particularly illustrates a time offset correction and channel estimation using shift in time domain window. It is to be noted that similar features are shown in particular to compliment the aspects described in accordance with FIG. 6 and particularly in accordance with FIG. 8. Features that are similar to the aspects described in FIGS. 6 and 8 have been numbered with a similar reference numeral in a manner that only the first numeral of the references are different (e.g. 1001 corresponds to 801, 1020 corresponds to 820, etc.). It is to be noted that similar features are to be structured similarly, operate similarly, and/or have the same function unless otherwise explicitly indicated.

In this exemplary block diagram, the channel estimation may include a time domain interference cancellation 1030 as an interference cancellation unit (e.g. the interference cancellation unit 630). In some examples, the processor may determine to bypass the frequency-domain interference cancellation, which the interference cancellation unit may perform. Similar to operations described for FIG. 8, in this example, a user separation unit may be illustrated as it includes a matched filter 1011 and a linear interpolator 1012, of which its operations are similar in accordance with the aspects described in FIG. 8, with a difference that the matched filter 1011 may receive an RS sequence X associated with the mobile radio communication device from a time offset circuit 1051 configured to apply a time offset \hat{τ} to the reference sequence X 1002 of the mobile radio communication device.

The processor may include a time offset estimator 1050. The time offset estimator may estimate a time offset \hat{τ} based on the output of the PDP estimator 1020, illustratively based on the PDP values 1005. In some aspects, the time offset operation may begin with a predetermined or a preset time offset, and as the processor estimates a further time offset \hat{τ} based on the output of the PDP estimator 1020, the processor may configure the time offset circuit 1051 to apply the further time offset \hat{τ}. Illustratively, the processor may obtain information about delays associated with interfering signals that are interfering to the transmit RS of the respective mobile radio communication device. In order to perform a time-domain interference cancellation based on these delays, the processor may adjust one or more signals illustrated to be used for the channel estimation to cancel their interference by time domain alignment. Illustratively, the processor 501 may perform a time offset correction based on the delays associated with the interfering signals (e.g. time delays estimated with the PDP estimation having peaks below a threshold or peaks that are not maximum peaks).

The reference sequence X 1002 may include an expected RS from the respective mobile radio communication device (i.e. a cyclically shifted reference sequence to which an assigned cyclic shift of the respective mobile radio communication device is applied). The time offset circuit 1051 may apply the determined time offset \hat{τ} to the reference sequence X 1002 by introducing the delay by multiplying the reference sequence X 1002 with e^{-jrπ}^{ₖ}^{\hat{τ}}, fₖ denoting the subcarrier frequency to obtain \tilde{X}. The matched filter 1011 may compute a correlation of inputs to determine a channel estimate Ĥᵤ^{(MF)} 1003a for the respective mobile radio communication device. In some alternative examples, the user separation unit may include a ZF precoder to determine that channel estimate for at least the respective mobile radio communication device, and optionally for all mobile radio communication devices. To provide a channel estimate over the entire bandwidth of the received signal Y, the channel estimate Ĥᵤ^{(MF)} 1003b may be fed into the linear interpolator 1012. The linear interpolator 1012 may interpolate the channel values included into Ĥᵤ^{(MF)} to obtain a linearly interpolated channel estimate for the respective mobile radio communication device Ĥᵤ^{(Lin)} 1003b.

The processor may further obtain a residual signal for the plurality of mobile radio communication devices. For this purpose, the linearly interpolated channel estimate for the respective mobile radio communication device Ĥᵤ^{(Lin)} 1003b is multiplied with the time offset applied reference sequence \tilde{X} to obtain Ĥᵤ^{(Lin)}\tilde{X}. In some aspects obtained linearly interpolated channel estimates for all mobile radio communication devices are accumulated and the residual signal Yᵣₑₛ(k) 1004 may be obtained by calculating the difference of the accumulation from the received signal Y.

The time domain interference cancellation unit 1030 may perform a time domain interference cancellation based on the residual signal Yᵣₑₛ(k) 1004, and the PDP values, and in some examples directly based on the determined time offset \hat{τ}. The residual signal Yᵣₑₛ(k) 1004 inherently includes interfering signals and the time domain interference cancellation unit 1030 may subtract the interfering signals from the residual signal Yᵣₑₛ(k) 1004 to obtain a residual channel estimate Ĥᵣₑₛ 1006a, which is then added to the linearly interpolated channel estimate for the respective mobile radio communication device Ĥᵤ^{(Lin)} 1003b to obtain an interference cancelled channel estimate for the respective mobile radio communication device Ĥᵤ^{(TDIC)} 1006b. The processor may further calculate an SNR estimate 1006c of an estimated desired signal. The LMMSE filter 1040 may also obtain the PDP values 1005 and the SNR 1006c and the processor may configure LMMSE filter coefficients of the LMMSE filter 1040 based on the SNR estimate 1006 and the PDP values 1005 to optimize the Ĥᵤ^{(TDIC)} 1006b and obtain a final channel estimate Ĥ 1009 as the channel information representative of the channel of the respective mobile radio communication device u.

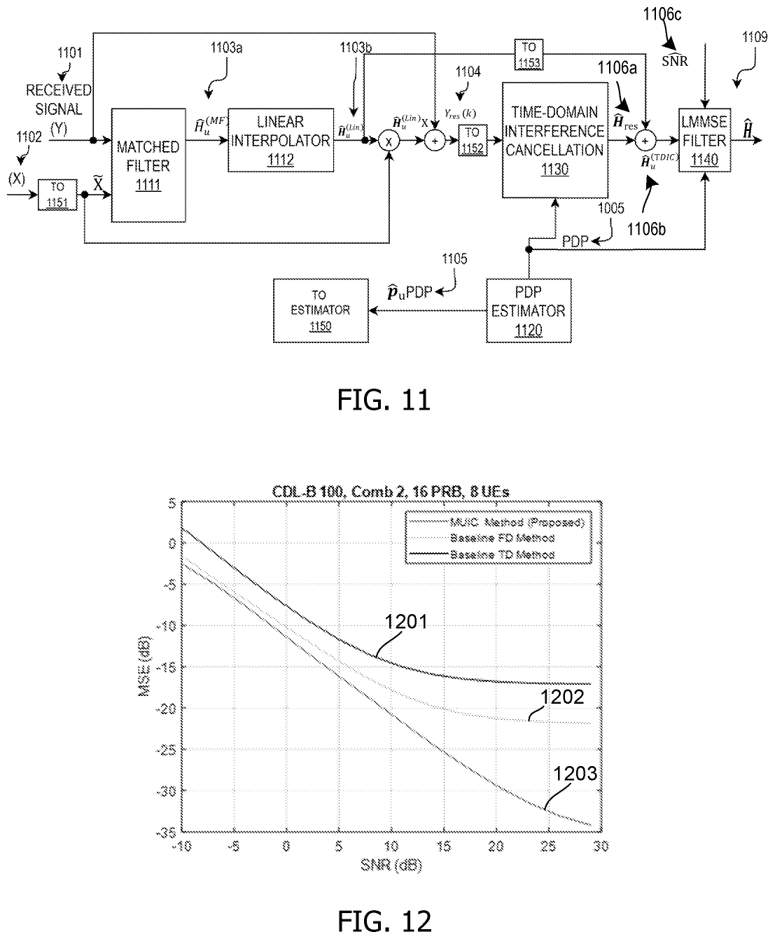

FIG. 11 shows an exemplary block diagram of a channel estimation in accordance with various aspects. In this illustrative example, the channel estimation may include a time domain interference cancellation unit and a time offset correction unit. In this constellation, the time domain interference cancellation unit, with the involvement of time offset correction, may reduce or cancel interference by aligning multipath components of the interference signals correctly according to a time offset \hat{τ} determined based on the PDP estimation. In this example, the offset corrections are applied not only to the reference sequence but also to the residual signal and the linearly interpolated channel estimate. This example particularly illustrates a time offset correction and channel estimation using channel rotation before time domain interference cancellation. A processor (e.g. the processor 501) may perform the channel estimation. It is to be noted that similar features are shown in particular to compliment the aspects described in accordance with FIG. 6 and particularly in accordance with FIG. 10. Features that are similar to the aspects described in FIGS. 6 and 10 have been numbered with a similar reference numeral in a manner that only the first numeral of the references are different (e.g. 1101 corresponds to 1001, 1120 corresponds to 1020, etc.). It is to be noted that similar features are to be structured similarly, operate similarly, and/or have the same function unless otherwise explicitly indicated.

In this exemplary block diagram, the channel estimation may include a time domain interference cancellation 1130 as an interference cancellation unit (e.g. the interference cancellation unit 1030). In some examples, the processor may determine to bypass the frequency-domain interference cancellation, which the interference cancellation unit may perform. Similar to operations described for FIG. 10, in this example, a user separation unit may be illustrated as it includes a matched filter 1111 and a linear interpolator 1112, of which its operations are similar in accordance with the aspects described in FIG. 10 including that the matched filter 1111 may receive an RS sequence X associated with the mobile radio communication device from a first time offset circuit 1151 configured to apply a time offset \hat{τ} to the reference sequence X 1102 of the mobile radio communication device.

The processor may include a time offset estimator 1150. The time offset estimator may estimate a time offset \hat{τ} based on the output of the PDP estimator 1120, illustratively based on the PDP values 1105. It is to be noted that drawing the connections between the time offset estimator 1150 and the time offset circuits 1051, 1052, and 1053 are omitted to avoid complexity of the drawing. In some aspects, the time offset operation may begin with a predetermined or a preset time offset, and as the processor estimates a further time offset \hat{τ} based on the output of the PDP estimator 1120, the processor may configure the time offset circuits 1151, 1152, 1153 to apply the further time offset \hat{τ}. Illustratively, the processor may obtain information about delays associated with interfering signals that are interfering to the transmit RS of the respective mobile radio communication device. In order to perform a time-domain interference cancellation based on these delays, the processor may adjust one or more signals illustrated to be used for the channel estimation to cancel their interference by time domain alignment. Illustratively, the processor 501 may perform a time offset correction based on the delays associated with the interfering signals (e.g. time delays estimated with the PDP estimation having peaks below a threshold or peaks that are not maximum peaks).

The reference sequence X 1102 may include an expected RS from the respective mobile radio communication device (i.e. a cyclically shifted reference sequence to which an assigned cyclic shift of the respective mobile radio communication device is applied). The first time offset circuit 1151 may apply the determined time offset \hat{τ} to the reference sequence X 1102 by introducing the delay by multiplying the reference sequence X 1102 with e^{-jrπ}^{ₖ}^{\hat{τ}}, fₖ denoting the subcarrier frequency to obtain \tilde{X}. The matched filter 1111 may compute a correlation of inputs to determine a channel estimate Ĥᵤ^{(MF)} 1103a for the respective mobile radio communication device. To provide a channel estimate over the entire bandwidth of the received signal Y, the channel estimate Ĥᵤ^{(MF)} 1103b may be fed into the linear interpolator 1112. The linear interpolator 1112 may interpolate the channel values included into Ĥᵤ^{(MF)} to obtain a linearly interpolated channel estimate for the respective mobile radio communication device Ĥᵤ^{(Lin)} 1103b.

The processor may further obtain a residual signal for the plurality of mobile radio communication devices. For this purpose, the linearly interpolated channel estimate for the respective mobile radio communication device Ĥᵤ^{(Lin)} 1103b is multiplied with the time offset applied reference sequence X to obtain Ĥᵤ^{(Lin)}\tilde{X}. In some aspects obtained linearly interpolated channel estimates for all mobile radio communication devices are accumulated and the residual signal Yᵣₑₛ(k) 1104 may be obtained by calculating the difference of the accumulation from the received signal Y.

A second time offset circuit 1052 may apply the determined time offset \hat{τ} to the residual signal Yᵣₑₛ(k) by introducing the delay by multiplying the residual signal Yᵣₑₛ(k) 1104 with e^{-jrπ}^{ₖ}^{\hat{τ}}, fₖ denoting the subcarrier frequency. Further, a third time offset circuit 1053 may apply the determined time offset \hat{τ} to the linearly interpolated channel estimate Ĥᵤ^{(Lin)} 1103b by introducing the delay by multiplying the linearly interpolated channel estimate Ĥᵤ^{(Lin)} 1103b with e^{-jrπ}^{ₖ}^{\hat{τ}}, fₖ denoting the subcarrier frequency.

The time domain interference cancellation unit 1130 may perform a time domain interference cancellation based on the time offset applied residual signal, and the PDP values, and in some examples directly based on the determined time offset \hat{τ}. The time offset applied residual signal inherently includes interfering signals and the time domain interference cancellation unit 1130 may subtract the interfering signals from the time offset applied residual signal to obtain a residual channel estimate Ĥᵣₑₛ 1106a, which is then added to the time offset applied linearly interpolated channel estimate to obtain an interference cancelled channel estimate for the respective mobile radio communication device Ĥᵤ^{(TDIC)} 1106b. The processor may further calculate an SNR estimate 1106c of an estimated desired signal. The LMMSE filter 1140 may also obtain the PDP values 1105 and the SNR 1106c and the processor may configure LMMSE filter coefficients of the LMMSE filter 1140 based on the SNR estimate 1106 and the PDP values 1105 to optimize the Ĥᵤ^{(TDIC)} 1106b and obtain a final channel estimate Ĥ 1109 as the channel information representative of the channel of the respective mobile radio communication device u.

Moreover, certain simulation results are described below in a scenario, in which the mobile radio communication devices are simulated as UEs, and the radio communication device is simulated as a BS that perform channel estimation using SRS symbols according to various aspects described in this disclosure. The configuration of SRSs are described in the table below:

| Parameters | Value |
|---|---|
| Sub-carrier spacing | 30 KHz |
| Number of PRB | 16 |
| Number of receive antennas | 64 |
| Pilot spacing (Comb size) | 2, 4 |
| Number of UEs | 8, 4 |
| LMMSE Filter Length | 12 |
| Evaluation 3GPP channel model | CDLB RMS Delay = 100 ns |
| SNR | Ideal |

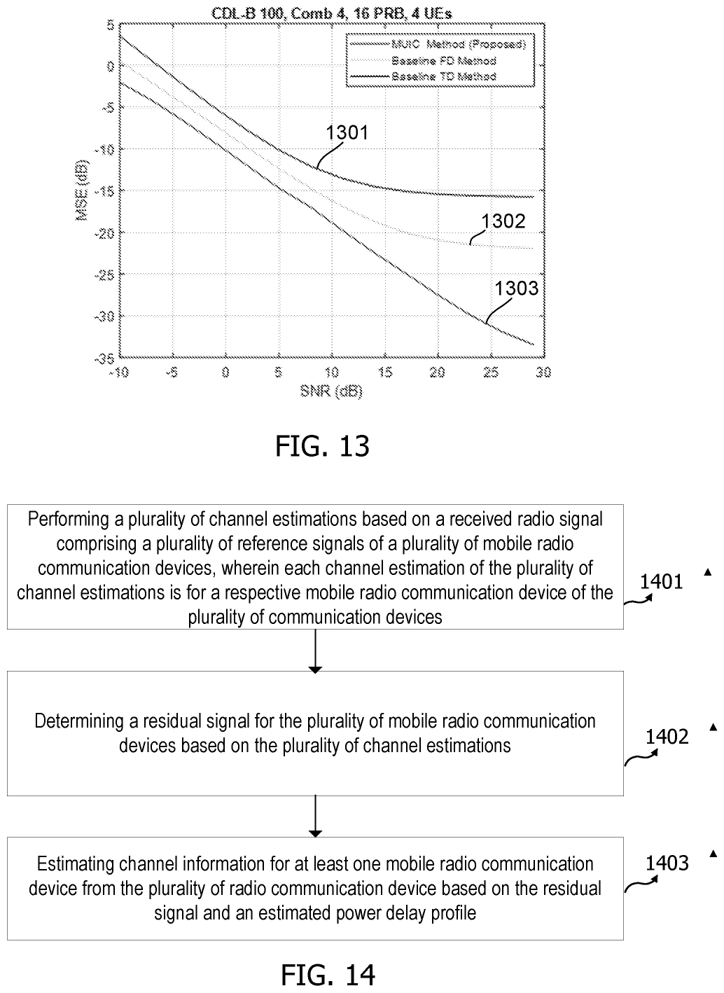

FIGS. 12 and 13 are exemplary graphs to compare the performance of various channel estimation methods. In these illustrations, a first channel estimation including a multiuser interference cancellation (MUIC) method of which aspects are described in this disclosure as the channel estimation to obtain channel information, a second channel estimation method including a Baseline Frequency Domain (FD) Method, which is a common state-of-the-art method that uses the Match Filter stage to perform user separation followed by LMMSE filter, and a third channel estimation method including a Baseline Time Domain (TD) Method, which is another common state-of-the-art method that performs user-specific time shift and windowing in time domain to perform user separation and channel estimation, are used.

FIG. 12 illustrates an exemplary graph illustrating the mean squared error performances of these channel estimations. The mean squared error performance of the first channel estimation is illustrated as 1201, the mean squared error performance of the second channel estimation is illustrated as 1202, and the mean squared error performance of the third channel estimation is illustrated as 1203. The numerical results are simulated for a scenario in which SRSs are SRS Comb type 2, i.e., pilot spaced every 2 subcarriers apart, and 8 UEs transmitting simultaneously on the same SRS resource. Note that the system is running at 100% user loading in this case.

FIG. 13 illustrates an exemplary graph illustrating the mean squared error performances of these channel estimations. The mean squared error performance of the first channel estimation is illustrated as 1301, the mean squared error performance of the second channel estimation is illustrated as 1302, and the mean squared error performance of the third channel estimation is illustrated as 1303. The numerical results are simulated for a scenario in which SRSs are SRS Comb type 4, i.e., pilot spaced every 4 subcarriers apart, and 4 UEs transmitting simultaneously on the same SRS resource. Note that the system is running at 33% user loading in this case.

FIG. 14 shows an example of a method. The method may include: performing 1401 a plurality of channel estimations based on a received radio signal comprising a plurality of reference signals of a plurality of mobile radio communication devices, wherein each channel estimation of the plurality of channel estimations is for a respective mobile radio communication device of the plurality of communication devices; determining 1402 a residual signal for the plurality of mobile radio communication devices based on the plurality of channel estimations; and estimating 1403 channel information for at least one mobile radio communication device from the plurality of radio communication device based on the residual signal and an estimated power delay profile. Exemplarily, a non-transitory computer-readable medium may include instructions which, if executed by a processor, cause the processor to perform the method.

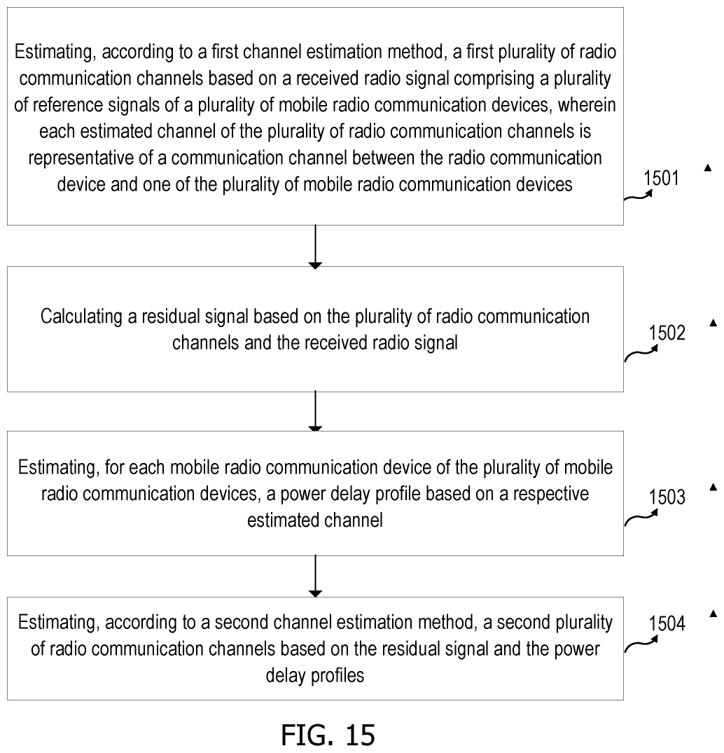

FIG. 15 shows an example of a method. The method that may include: estimating 1501, according to a first channel estimation method, a first plurality of radio communication channels based on a received radio signal comprising a plurality of reference signals of a plurality of mobile radio communication devices, wherein each estimated channel of the plurality of radio communication channels is representative of a communication channel between the radio communication device and one of the plurality of mobile radio communication devices; calculating 1502 a residual signal based on the plurality of radio communication channels and the received radio signal; estimating 1503, for each mobile radio communication device of the plurality of mobile radio communication devices, a power delay profile based on a respective estimated channel; estimating 1504, according to a second channel estimation method, a second plurality of radio communication channels based on the residual signal and the power delay profiles. Exemplarily, a non-transitory computer-readable medium may include instructions which, if executed by a processor, cause the processor to perform the method.

The following examples pertain to further aspects of this disclosure.

In Example 1, the subject matter includes a radio communication device that may include: a memory; and a processor configured to: perform a plurality of channel estimations based on a received radio signal may include a plurality of reference signals of a plurality of mobile radio communication devices, wherein each channel estimation of the plurality of channel estimations is for a respective mobile radio communication device of the plurality of communication devices; determine a residual signal for the plurality of mobile radio communication devices based on the plurality of channel estimations; estimate channel information for at least one mobile radio communication device from the plurality of radio communication device based on the residual signal and an estimated power delay profile.

In Example 2 or any one of Examples provided herein, the subject matter of example 1, wherein the plurality of reference signals includes a reference signal for each mobile radio communication device, wherein each reference signal is orthogonal to other reference signals of the plurality of reference signals.

In Example 3, the subject matter of example 1 or example 2, wherein the respective channel estimation of the at least one mobile radio communication device being a first channel estimation of the at least one mobile radio communication device; wherein the channel information is obtained based on a second channel estimation and the estimated power delay profile is based on the first channel estimation of the at least one mobile radio communication device.

In Example 4, the subject matter of example 3, wherein the processor is further configured to determine a channel quality indicator for the at least one mobile radio communication signal based on an output of the second channel estimation for the at least one mobile radio communication device.

In Example 5, the subject matter of any one of examples 1 to 4, wherein, for each mobile radio communication device of the plurality of mobile radio communication devices, the processor is configured to determine a corresponding reference signal and a corresponding estimation of a power delay profile based on the respective channel estimation of the respective mobile radio communication device.

In Example 6, the subject matter of example 5, wherein, for each mobile radio communication device of the plurality of radio communication devices, the processor is further configured to determine a further channel estimation based on the corresponding reference signal of the respective mobile radio communication device.

In Example 7, the subject matter of any one of examples 1 to 6, wherein each channel estimation of the plurality of channel estimations is a coarse channel estimation.

In Example 8, the subject matter of any one of examples 1 to 7, wherein the processor is further configured to perform a linear interpolation to an output of a matched filter configured for a reference waveform with a sequence length for orthogonality.

In Example 9, the subject matter of any one of examples 1 to 8, wherein the processor further includes a power delay profile (PDP) estimator configured to perform the power delay profile estimation to obtain estimated PDP values for the respective mobile radio communication device.

In Example 10, the subject matter of claim 9, wherein the PDP estimator includes a trained neural network configured to receive input data may include a respective channel estimation of for the respective and provide an output may include estimated PDP values for the respective mobile radio communication device based on the input data and neural network parameters.

In Example 11, the subject matter of example 10, wherein the neural network includes a domain knowledge enhanced neural network, wherein a domain knowledge enhanced neural network is a maximum likelihood estimator of power delay profile.

In Example 12, the subject matter of example 10 or example 11, wherein the neural network is trained via a supervised training.

In Example 13, the subject matter of any one of claims 9 to 12, wherein the processor is further configured to perform a time domain interference cancellation to the residual signal based on a corresponding reference signal.

In Example 14, the subject matter of example 13, wherein the processor is further configured to perform an inverse discrete Fourier transform of a product of the residual signal and a complex-conjugate of a respective reference signal for the at least one mobile radio communication device to extract time domain taps for the corresponding reference signal of the at least one mobile radio communication device; wherein tap lengths to identify the time domain taps are based on the estimated PDP values.

In Example 15, the subject matter of example 14, wherein the processor is further configured to determine a number of taps based on a mean delay and a root mean squared delay spread of the estimated PDP values.

In Example 16, the subject matter of any one of claims 9 to 12, wherein the processor is further configured to perform a frequency domain interference cancellation based on the residual signal to determine the channel information.

In Example 17, the subject matter of any one of claims 9 to 16, wherein the processor further includes a denoising filter configured based on the estimated PDP values.

In Example 18, the subject matter of example 17, wherein the denoising filter includes a linear minimum mean squared (LMMSE) filter configured to apply filter coefficients calculated based on the estimated PDP values to the respective channel estimation of the at least one mobile radio communication device and the transmit signal.

In Example 19, the subject matter of any one of claims 9 to 18, wherein the processor is further configured to perform a time-offset correction based on the estimated PDP values.

In Example 20, the subject matter of example 19, wherein the time offset correction is applied to an output of the denoising filter, wherein first the time offset estimation is obtained from the estimated power delay profile.

In Example 21, the subject matter of example 19 or example 20, wherein the time offset correction is applied to the respective channel estimation for the at least one mobile radio communication signal.

In Example 22, the subject matter of any one of claims 1 to 21, wherein the processor is further configured to determine a channel quality indicator for the at least one mobile radio communication signal based on the transmit signal.

In Example 23, the subject matter of any one of claims 1 to 22, wherein each reference signal is a sounding reference signal.

In Example 24, the subject matter of any one of claims 1 to 23, may further include a radio frequency interface configured to receive a radio signal from one or more antennas.

In Example 25, the subject matter of example 24, may further include a radio frequency circuit coupled to the radio frequency interface, wherein the radio frequency circuit is couplable to the one or more antennas.

In Example 26, a radio communication device may include: a memory; and a processor configured to: estimate, according to a first channel estimation method, a first plurality of radio communication channels based on a received radio signal may include a plurality of reference signals of a plurality of mobile radio communication devices, wherein each estimated channel of the plurality of radio communication channels is representative of a communication channel between the radio communication device and one of the plurality of mobile radio communication devices; calculate a residual signal based on the plurality of radio communication channels and the received radio signal; estimate, for each mobile radio communication device of the plurality of mobile radio communication devices, a power delay profile based on a respective estimated channel; estimate, according to a second channel estimation method, a second plurality of radio communication channels based on the residual signal and the power delay profiles.

In Example 27, the radio communication device of example 26, wherein the radio communication device is configured to perform any one of the aspects described in this description, in particular the aspects described in any one of examples 2 to 26.

In Example 28, the subject matter includes a method that may include: performing a plurality of channel estimations based on a received radio signal may include a plurality of reference signals of a plurality of mobile radio communication devices, wherein each channel estimation of the plurality of channel estimations is for a respective mobile radio communication device of the plurality of communication devices; determining a residual signal for the plurality of mobile radio communication devices based on the plurality of channel estimations; estimating channel information for at least one mobile radio communication device from the plurality of radio communication device based on the residual signal and an estimated power delay profile.

In Example 29, the subject matter of example 28, wherein the plurality of reference signals includes a reference signal for each mobile radio communication device, wherein each reference signal is orthogonal to other reference signals of the plurality of reference signals.

In Example 30, the subject matter of example 28 or example 29, wherein the respective channel estimation of the at least one mobile radio communication device being a first channel estimation of the at least one mobile radio communication device; wherein the channel information is obtained based on a second channel estimation and the estimated power delay profile is based on the first channel estimation of the at least one mobile radio communication device.

In Example 31, the subject matter of example 30, may further include: determining a channel quality indicator for the at least one mobile radio communication signal based on an output of the second channel estimation for the at least one mobile radio communication device.

In Example 32, the subject matter of any one of examples 28 to 31, may further include: for each mobile radio communication device of the plurality of mobile radio communication devices, determining a corresponding reference signal and a corresponding estimation of a power delay profile based on the respective channel estimation of the respective mobile radio communication device.

In Example 33, the subject matter of example 32, may further include: for each mobile radio communication device of the plurality of radio communication devices, determining a further channel estimation based on the corresponding reference signal of the respective mobile radio communication device.

In Example 34, the subject matter of any one of examples 28 to 33, wherein each channel estimation of the plurality of channel estimations is a coarse channel estimation.

In Example 35, the subject matter of any one of examples 28 to 34, may further include: performing a linear interpolation to an output of a matched filter configured for a reference waveform with a sequence length for orthogonality.

In Example 36, the subject matter of any one of examples 28 to 35, may further include: performing the power delay profile estimation to obtain estimated PDP values for the respective mobile radio communication device.

In Example 37, the subject matter of example 36, wherein the PDP estimator includes a trained neural network to receive input data may include a respective channel estimation of for the respective and provide an output may include estimated PDP values for the respective mobile radio communication device based on the input data and neural network parameters.

In Example 38, the subject matter of example 37, wherein the neural network includes a domain knowledge enhanced neural network, wherein a domain knowledge enhanced neural network is a maximum likelihood estimator of power delay profile.

In Example 39, the subject matter of example 37 or example 38, wherein the neural network is trained via a supervised training.

In Example 40, the subject matter of any one of examples 36 to 39, may further include: performing a time domain interference cancellation to the residual signal based on a corresponding reference signal.

In Example 41, the subject matter of example 40, may further include: performing an inverse discrete Fourier transform of a product of the residual signal and a complex-conjugate of a respective reference signal for the at least one mobile radio communication device to extract time domain taps for the corresponding reference signal of the at least one mobile radio communication device; wherein tap lengths to identify the time domain taps are based on the estimated PDP values.

In Example 42, the subject matter of example 41, may further include: determining a number of taps based on a mean delay and a root mean squared delay spread of the estimated PDP values.

In Example 43, the subject matter of any one of examples 37 to 42, may further include: performing a frequency domain interference cancellation based on the residual signal to determine the channel information.

In Example 44, the subject matter of any one of examples 37 to 43, may further include: using a denoising filter configured based on the estimated PDP values.

In Example 45, the subject matter of example 44, wherein the denoising filter includes a linear minimum mean squared (LMMSE) filter to apply filter coefficients calculated based on the estimated PDP values to the respective channel estimation of the at least one mobile radio communication device and the transmit signal.

In Example 46, the subject matter of any one of examples 36 to 45, may further include: performing a time-offset correction based on the estimated PDP values.

In Example 47, the subject matter of example 46, may further include: applying the time offset correction to an output of the denoising filter, wherein first the time offset estimation is obtained from the estimated power delay profile.

In Example 48, the subject matter of example 46 or example 47, may further include: applying the time offset correction to the respective channel estimation for the at least one mobile radio communication signal.

In Example 49, the subject matter of any one of examples 28 to 48, may further include: determining a channel quality indicator for the at least one mobile radio communication signal based on the transmit signal.

In Example 50, the subject matter of any one of examples 28 to 49, wherein each reference signal is a sounding reference signal.

In Example 51, a method may include: estimating, according to a first channel estimation method, a first plurality of radio communication channels based on a received radio signal may include a plurality of reference signals of a plurality of mobile radio communication devices, wherein each estimated channel of the plurality of radio communication channels is representative of a communication channel between the radio communication device and one of the plurality of mobile radio communication devices; calculating a residual signal based on the plurality of radio communication channels and the received radio signal; estimating, for each mobile radio communication device of the plurality of mobile radio communication devices, a power delay profile based on a respective estimated channel; estimating, according to a second channel estimation method, a second plurality of radio communication channels based on the residual signal and the power delay profiles.

In Example 52, method of example 51, wherein the method further includes any one of the aspects described in this description, in particular the aspects described in any one of examples 28 to 50.

In Example 53, a non-transitory computer-readable medium may include one or more instructions which, if executed by a processor, cause the processor to perform the method of any one of examples 28 to 53.

The word “exemplary” is used herein to mean “serving as an example, instance, or illustration”. Any embodiment or design described herein as “exemplary” is not necessarily to be construed as preferred or advantageous over other embodiments or designs.

The words “plurality” and “multiple” in the description or the claims expressly refer to a quantity greater than one. The terms “group (of)”, “set [of]”, “collection (of)”, “series (of)”, “sequence (of)”, “grouping (of)”, etc., and the like in the description or in the claims refer to a quantity equal to or greater than one, i.e. one or more. Any term expressed in plural form that does not expressly state “plurality” or “multiple” likewise refers to a quantity equal to or greater than one.

Any vector and/or matrix notation utilized herein is exemplary in nature and is employed solely for purposes of explanation. Accordingly, the apparatuses and methods of this disclosure accompanied by vector and/or matrix notation are not limited to being implemented solely using vectors and/or matrices, and that the associated processes and computations may be equivalently performed with respect to sets, sequences, groups, etc., of data, observations, information, signals, samples, symbols, elements, etc.

As used herein, “memory” is understood as a non-transitory computer-readable medium in which data or information can be stored for retrieval. References to “memory” included herein may thus be understood as referring to volatile or non-volatile memory, including random access memory (“RAM”), read-only memory (“ROM”), flash memory, solid-state storage, magnetic tape, hard disk drive, optical drive, etc., or any combination thereof. Furthermore, registers, shift registers, processor registers, data buffers, etc., are also embraced herein by the term memory. A single component referred to as “memory” or “a memory” may be composed of more than one different type of memory, and thus may refer to a collective component including one or more types of memory. Any single memory component may be separated into multiple collectively equivalent memory components, and vice versa. Furthermore, while memory may be depicted as separate from one or more other components (such as in the drawings), memory may also be integrated with other components, such as on a common integrated chip or a controller with an embedded memory.

The term “software” refers to any type of executable instruction, including firmware.

In the context of this disclosure, the term “process” may be used, for example, to indicate a method. Illustratively, any process described herein may be implemented as a method (e.g., a channel estimation process may be understood as a channel estimation method). Any process described herein may be implemented as a non-transitory computer readable medium including instructions configured, when executed, to cause one or more processors to carry out the process (e.g., to carry out the method).

Throughout the drawings, it should be noted that like reference numbers are used to depict the same or similar elements, features, and structures, unless otherwise noted. It should be noted that certain components may be omitted for the sake of simplicity. It should be noted that nodes (dots) are provided to identify the circuit line intersections in the drawings including electronic circuit diagrams.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

As used herein, a signal or information that is “indicative of”, “representative”, “representing”, or “indicating” a value or other information may be a digital or analog signal that encodes or otherwise, communicates the value or other information in a manner that can be decoded by and/or cause a responsive action in a component receiving the signal. The signal may be stored or buffered in computer-readable storage medium prior to its receipt by the receiving component and the receiving component may retrieve the signal from the storage medium. Further, a “value” that is “indicative of” or “representative” some quantity, state, or parameter may be physically embodied as a digital signal, an analog signal, or stored bits that encode or otherwise communicate the value.

As used herein, a signal may be transmitted or conducted through a signal chain in which the signal is processed to change characteristics such as phase, amplitude, frequency, and so on. The signal may be referred to as the same signal even as such characteristics are adapted. In general, so long as a signal continues to encode the same information, the signal may be considered as the same signal. For example, a transmit signal may be considered as referring to the transmit signal in baseband, intermediate, and radio frequencies.

The terms “processor” or “controller” as, for example, used herein may be understood as any kind of technological entity that allows handling of data. The data may be handled according to one or more specific functions executed by the processor. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The terms “one or more processors” is intended to refer to a processor or a controller. The one or more processors may include one processor or a plurality of processors. The terms are simply used as an alternative to the “processor” or “controller”.

The term “user device” is intended to refer to a device of a user (e.g. occupant) that may be configured to provide information related to the user. The user device may exemplarily include a mobile phone, a smart phone, a wearable device (e.g. smart watch, smart wristband), a computer, etc.

As utilized herein, terms “module”, “component,” “system,” “circuit,” “element,” “slice,” “circuit,” and the like are intended to refer to a set of one or more electronic components, a computer-related entity, hardware, software (e.g., in execution), and/or firmware. For example, circuit or a similar term can be a processor, a process running on a processor, a controller, an object, an executable program, a storage device, and/or a computer with a processing device. By way of illustration, an application running on a server and the server can also be circuit. One or more circuits can reside within the same circuit, and circuit can be localized on one computer and/or distributed between two or more computers. A set of elements or a set of other circuits can be described herein, in which the term “set” can be interpreted as “one or more”.

The terminology in accordance with open-RAN (O-RAN) specifications is to be considered for Radio Units (RUs), Distributed Units (DUs) and Centralized Units (CUs). Inherently, a base station is considered to be disaggregated into such units in accordance with layers of a corresponding protocol stack into these logical nodes, which all of them can be implemented by the same device or multiple devices in which each device may be deployed with one of these units.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art. The term “data item” may include data or a portion of data.

It will be understood that when an element is referred to as being “connected” or “coupled” to another element, it can be physically connected or coupled to the other element such that current and/or electromagnetic radiation (e.g., a signal) can flow along a conductive path formed by the elements. Inherently, such element is connectable or couplable to the another element. Intervening conductive, inductive, or capacitive elements may be present between the element and the other element when the elements are described as being coupled or connected to one another. Further, when coupled or connected to one another, one element may be capable of inducing a voltage or current flow or propagation of an electro-magnetic wave in the other element without physical contact or intervening components. Further, when a voltage, current, or signal is referred to as being “provided” to an element, the voltage, current, or signal may be conducted to the element by way of a physical connection or by way of capacitive, electro-magnetic, or inductive coupling that does not involve a physical connection.

Unless explicitly specified, the term “instance of time” refers to a time of a particular event or situation according to the context. The instance of time may refer to an instantaneous point in time, or to a period of time which the particular event or situation relates to.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

An antenna port may be understood as a logical concept representing a specific channel or associated with a specific channel. An antenna port may be understood as a logical structure associated with a respective channel (e.g., a respective channel between a user equipment and a base station). Illustratively, symbols (e.g., OFDM symbols) transmitted over an antenna port (e.g., over a first channel) may be subject to different propagation conditions with respect to other symbols transmitted over another antenna port (e.g., over a second channel).

While the above descriptions and connected figures may depict electronic device components as separate elements, skilled persons will appreciate the various possibilities to combine or integrate discrete elements into a single element. Such may include combining two or more circuits to form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method. All acronyms defined in the above description additionally hold in all claims included herein.

What is claimed is:

1. A radio communication device comprising:
a memory; and
a processor configured to:
perform a plurality of channel estimations based on a received radio signal comprising a plurality of reference signals of a plurality of mobile radio communication devices, wherein each channel estimation of the plurality of channel estimations is for a respective mobile radio communication device of the plurality of communication devices;
determine a residual signal for the plurality of mobile radio communication devices based on the plurality of channel estimations; and
estimate channel information for at least one mobile radio communication device from the plurality of radio communication device based on the residual signal and an estimated power delay profile.

2. The radio communication device of claim 1,
wherein the plurality of reference signals comprises a reference signal for each mobile radio communication device, wherein each reference signal is orthogonal to other reference signals of the plurality of reference signals.

3. The radio communication device of claim 1,
wherein the respective channel estimation of the at least one mobile radio communication device being a first channel estimation of the at least one mobile radio communication device;
wherein the channel information is obtained based on a second channel estimation and the estimated power delay profile is based on the first channel estimation of the at least one mobile radio communication device.

4. The radio communication device of claim 1,
wherein, for each mobile radio communication device of the plurality of mobile radio communication devices, the processor is configured to determine a corresponding reference signal and a corresponding estimation of a power delay profile based on the respective channel estimation of the respective mobile radio communication device.

5. The radio communication device of claim 1,
wherein each channel estimation of the plurality of channel estimations is a coarse channel estimation.

6. The radio communication device of claim 1,
wherein the processor further comprises a power delay profile (PDP) estimator configured to perform the power delay profile estimation to obtain estimated PDP values for the respective mobile radio communication device.

7. The radio communication device of claim 6,
wherein the PDP estimator comprises a trained neural network configured to receive input data comprising a respective channel estimation of for the respective and provide an output comprising estimated PDP values for the respective mobile radio communication device based on the input data and neural network parameters.

8. The radio communication device of claim 6,
wherein the processor is further configured to perform an inverse discrete Fourier transform of a product of the residual signal and a complex-conjugate of a respective reference signal for the at least one mobile radio communication device to extract time domain taps for the corresponding reference signal of the at least one mobile radio communication device;
wherein tap lengths to identify the time domain taps are based on the estimated PDP values.

9. The radio communication device of claim 6,
wherein the processor is further configured to perform a frequency domain interference cancellation based on the residual signal to determine the channel information.

10. The radio communication device of claim 6,
wherein the processor further comprises a denoising filter configured based on the estimated PDP values;
wherein the denoising filter comprises a linear minimum mean squared (LMMSE) filter configured to apply filter coefficients calculated based on the estimated PDP values to the respective channel estimation of the at least one mobile radio communication device and the transmit signal.

11. The radio communication device of claim 6,
wherein the processor is further configured to perform a time-offset correction based on the estimated PDP values.

12. The radio communication device of claim 11,
wherein the time offset correction is applied to the respective channel estimation for the at least one mobile radio communication signal.

13. The radio communication device of claim 1,
wherein each reference signal is a sounding reference signal.

14. A radio communication device comprising:
a memory; and
a processor configured to:
estimate, according to a first channel estimation method, a first plurality of radio communication channels based on a received radio signal comprising a plurality of reference signals of a plurality of mobile radio communication devices, wherein each estimated channel of the plurality of radio communication channels is representative of a communication channel between the radio communication device and one of the plurality of mobile radio communication devices;
calculate a residual signal based on the plurality of radio communication channels and the received radio signal;
estimate, for each mobile radio communication device of the plurality of mobile radio communication devices, a power delay profile based on a respective estimated channel; and
estimate, according to a second channel estimation method, a second plurality of radio communication channels based on the residual signal and the power delay profiles.

15. The radio communication device of claim 14,
wherein the respective channel estimation of the at least one mobile radio communication device being a first channel estimation of the at least one mobile radio communication device;
wherein the channel information is obtained based on a second channel estimation and the estimated power delay profile is based on the first channel estimation of the at least one mobile radio communication device.

16. The radio communication device of claim 14,
wherein, for each mobile radio communication device of the plurality of mobile radio communication devices, the processor is configured to determine a corresponding reference signal and a corresponding estimation of a power delay profile based on the respective channel estimation of the respective mobile radio communication device.

17. The radio communication device of claim 14,
wherein the processor further comprises a power delay profile (PDP) estimator configured to perform the power delay profile estimation to obtain estimated PDP values for the respective mobile radio communication device.

18. The radio communication device of claim 17,
wherein the PDP estimator comprises a trained neural network configured to receive input data comprising a respective channel estimation of for the respective and provide an output comprising estimated PDP values for the respective mobile radio communication device based on the input data and neural network parameters.

19. A non-transitory computer-readable medium comprising one or more instructions which, if executed by a processor, cause the processor to:
perform a plurality of channel estimations based on a received radio signal comprising a plurality of reference signals of a plurality of mobile radio communication devices, wherein each channel estimation of the plurality of channel estimations is for a respective mobile radio communication device of the plurality of communication devices;
determine a residual signal for the plurality of mobile radio communication devices based on the plurality of channel estimations; and
estimate channel information for at least one mobile radio communication device from the plurality of radio communication device based on the residual signal and an estimated power delay profile.

20. The non-transitory computer-readable medium of claim 19,
wherein each channel estimation of the plurality of channel estimations is a coarse channel estimation.
